(19) United States
(12) Patent Application Publication
(10) Pub. No.: US 2019/0204678 A1
(43) Pub. Date: Jul. 4, 2019

(54) LIGHTING DEVICE AND DISPLAY DEVICE

(71) Applicant: SHARP KABUSHIKI KAISHA, Sakai City, Osaka (JP)

(72) Inventor: MITSURU HOSOKI, Sakai City (JP)

(21) Appl. No.: 16/330,296

(22) PCT Filed: Aug. 29, 2017
(86) PCT No.: PCT/JP2017/030864

§ 371 Date: Mar. 4, 2019

(30) Foreign Application Priority Data
Sep. 5, 2016 (JP) 2016-172735

(51) Int. Cl. G02F 1/1335; F21V 8/00

(52) U.S. Cl. CPC G02F 1/133536; G02B 6/0056; G02B 6/0055; G02B 6/0053; G02B 6/0051

(57) ABSTRACT

A backlight device includes a reflective polarizing sheet, a first sheet support part which supports one end side of the reflective polarizing sheet in a first direction, a first supported part having a first opening through which the first sheet support part passes through and supported by the first sheet support part, a microlens sheet stacked on the reflective polarizing sheet and having a coefficient of linear expansion different from a coefficient of linear expansion of the reflective polarizing sheet, a second sheet support part which supports one end side of the microlens sheet, and a second supported part supported by the second sheet support part, the second supported part disposed at a position not superposed on at least the first opening.

### TECHNICAL FIELD

The present invention relates to lighting devices and display devices.

### BACKGROUND ART

As an example of conventional liquid crystal display devices, one described in the following PTL 1 is known. In this liquid crystal display device described in PTL 1, in fixing both of a liquid crystal panel and an optical film included in a backlight by a light-shielding sheet, an opening of the light-shielding sheet is formed so as to be larger than a display part of the liquid crystal display panel and the outer shape of the optical film is formed so as to be larger than the display part of the liquid crystal display panel and smaller than the opening of the light-shielding sheet, a protruding piece is provided to be fixedly attached to the outer edge of the optical film.

### RELATED ART DOCUMENT

### Patent Literature

### [Patent Literature 1] Japanese Unexamined Patent Application Publication No. 2005-24774

### Problem to be Solved by the Invention

In the above-described liquid crystal display device described in PTL 1, one protruding piece provided to the outer edge of the optical film is fixedly attached as squeezing below the light-shielding sheet. However, when the size of the optical film is increased as the size of the liquid crystal display device is increased, if the optical film is fixed by one protruding piece as described above, there is a concern about an occurrence of a sag or the like due to its own weight. To prevent this, it is considered to adopt a configuration in which, for example, the optical film is supported as being suspended. However, when a plurality of optical films with different coefficients of linear expansion are laminated and arranged, if adhesion occurs between support structures of the overlapping optical films, the support structures cannot make relative displacement with thermal expansion and, as a result, deformation such as a wrinkle may occur to an optical film.

### DISCLOSURE OF THE PRESENT INVENTION

The present invention has been completed based on circumstances as described above, and has an object of making each sheet member less deformable.

### Means for Solving the Problem

A lighting device of the present invention includes: a first sheet member having a surface parallel to a first direction and a second direction orthogonal to each other; a first sheet support part which supports one end side of the first sheet member in the first direction; a first supported part provided on the one end side of the first sheet member and close to an end with respect to a center position in the second direction, having a first opening which the first sheet support part passes through, and supported by the first sheet support part; a second sheet member having a surface parallel to the surface of the first sheet member, stacked on the first sheet member, and having a coefficient of linear expansion different from a coefficient of linear expansion of the first sheet member; a second sheet support part which supports the one end side of the second sheet member; and a second supported part provided on the one end side of the second sheet member and close to the end with respect to the center position in the second direction and supported by the second sheet support part, the second supported part disposed at a position not superposed on at least the first opening.

With this, the first sheet member is supported in the first direction, with the first supported part provided on one end side in the first direction and close to the end with respect to the center position in the second direction being supported by the first sheet support part where the first supported part passes through the first opening. The second sheet member stacked on the first sheet member is supported in the first direction, with the second supported part provided on one end side in the first direction and close to the end with respect to the center position in the second direction being supported by the second sheet support part. Each sheet member thermally expand in the first direction and the second direction as the temperature of the temperature environment is increased. In the following, the operation regarding the second direction is descried in detail. When each sheet member thermally expands in the second direction, each supported part is relatively displaced in the second direction with respect to each sheet support part accordingly. As described above, since the first sheet member and the second sheet member have different coefficients of linear expansion, the first supported part and the second supported part have different deformation amounts in the second direction with thermal expansion.

The first opening is formed in at least the first supported part, and there is a possibility that a protrusion such as a burr is formed on its opening edge due to a reason in manufacture. If this protrusion is caught on the second supported part, the first supported part and the second supported part may stick to each other to inhibit relative displacement. By contrast, the second supported part is disposed at a position not superposed on at least the first opening, even if a protrusion such as a burr is formed on the opening edge of the first opening, the situation hardly occurs in which that protrusion is caught on the second supported part. With this, the first supported part and the second supported part hardly stick to each other. Therefore, even if the displacement amounts of the first supported part and the second supported part in the second direction with thermal expansion are different, relative displacement between the first supported part and the second supported part is allowed, and thus deformation such as a wrinkle hardly occurs in each sheet member.

The following structures are preferable as embodiments of the present invention.

(1) The second supported part has a second opening which the second sheet support part passes through. With this, the second sheet member is supported in the first direction, with the second supported part being supported by the second sheet support part which passing through the second opening. In addition to the first opening of the first supported part, the second opening of the second supported part may have a protrusion such as burr formed due to a reason in manufacture. However, the second opening is formed in the second supported part so as not to be superposed on the first opening, and both of the openings are arranged so as not to be superposed each other. Therefore, when the protrusion is formed on the opening edge of any first opening, the situation hardly occurs in which that protrusion is caught on the opening edge of the second opening. Conversely, when the protrusion is formed on the opening edge of the second opening, the situation hardly occurs in which that protrusion is caught on the opening edge of the first opening. With this, the first supported part and the second supported part hardly stick to each other, and each sheet member is made further less deformable.

(2) The second supported part has the second opening disposed at a position not superposed on the first supported part. With this, when a protrusion such as a burr occurs on the opening edge of the second opening, the situation hardly occurs in which that protrusion is caught on the first supported part. With this, the first supported part and the second supported part is prevented from sticking to each other, and each sheet member is made further less deformable.

(3) The second supported part is disposed at a position not superposed on the first supported part. With this, when a protrusion such as a burr is formed on the outer edge of any supported part due to a reason in manufacture, the situation hardly occurs in which that protrusion is caught on the outer edge of any supported part or the opening edge of the first opening. With this, the first supported part and the second supported part is prevented from sticking to each other, and each sheet member is made less deformable.

(4) The device includes: a center-side sheet support part which supports a center side in the second direction on the one end side of the first sheet member and the second sheet member; a first center-side supported part provided on the one end side of the first sheet member and at a center position in the second direction, having a first center-side opening which the center-side sheet support part passes through, and supported by the center-side sheet support part; and a second center-side supported part provided on the one end side of the second sheet member and at the center position in the second direction, superposed on the first center-side opening, having a second center-side opening which the center-side sheet support part passes through, and supported by the center-side sheet support part. With this, the first center-side supported part and the second center-side supported part are provided with the first center-side opening and the second center-side opening superposed each other, respectively, and the common center-side sheet support part passes through these first center-side opening and second center-side opening, and thereby the first sheet member and the second sheet member is supported on the center side in the second direction. In this manner, with the center-side sheet support part being shared in common, the structure is simplified. The first center-side supported part and the second center-side supported part are portions are portions serving as origins when each sheet member extends along the second direction at the time of thermal expansion, therefore hardly make relative displacement with thermal expansion in the second direction with respect to the center-side sheet support part, and are thus prevented from causing deformation such as a wrinkle in each sheet member.

(5) Either one of the first sheet member and the second sheet member serves as a heavy sheet member which is relatively heavy and another one serves as a light-weight sheet member which has a relatively light weight, and the heavy sheet member has a larger number of installations of the first supported part or the second supported part than the light-weight sheet member. The heavy sheet member is relatively heavy compared with the light-weight sheet member, and therefore the loads on the first supported part or the second supported part as a support location by the first sheet support part or the second sheet support part is large. In this regard, the heavy sheet member has the larger number of installations of the first supported parts or the second supported parts than the light-weight sheet member. Therefore, the loads on the first supported parts or the second supported parts are distributed. With this, the situation hardly occurs in which any first supported part or second supported part is damaged or the like by the weight of the heavy sheet member, and stable support can be achieved.

(6) The second sheet member has the coefficient of linear expansion smaller than the coefficient of linear expansion of the first sheet member, and the second supported part forms a non-opening protrusion piece shape protruding from an outer edge of the second sheet member along the second direction. With this, the second supported part forms a protrusion piece shape protruding from the outer edge of the second sheet member along the second direction and is thus supported by the second sheet support part even in the case of non-opening. The size of the second supported part is decreased by being non-opening. Also, the second sheet member has a coefficient of linear expansion smaller than that of the first sheet member, and therefore the displacement amount in the second direction with thermal expansion regarding the second supported part is relatively small, compared with the displacement amount regarding the first supported part. This is suitable for making the lighting device as a narrow picture frame.

(7) Either one of the first sheet member and the second sheet member serves as a thick sheet member which is relatively thick and another one serves as a thin sheet member which is relatively thin, and the thin sheet member is disposed so as to be stacked on a side of the thick sheet member opposite to an output light side. With this, the thin sheet member is relatively thin, compared with the thick sheet member, and therefore deformation such as a wrinkle intrinsically tends to occur. Therefore, by disposing the thin sheet member so as to be stacked on the side of the thick sheet member opposite to the output light side as described above, even in the event of that deformation such as a wrinkle occurs in the thin sheet member, that deformation is hardly visually recognized from a user of the lighting device.

(8) The first sheet member and the second sheet member serve as a first optical sheet and a second optical sheet, respectively, each of which provides optical action to light, the lighting device comprises a frame-shaped member which forms a frame shape so as to extend along an outer edge of the first optical sheet and the second optical sheet and also delimits an effective output light area of the first optical sheet and the second optical sheet, and the first sheet support part and the second sheet support part are provided to the frame-shaped member. With this, the first optical sheet and the second optical sheet in which the effective output light area is delimited by the frame-shaped member are supported by the first sheet support part and the second sheet support part provided to the frame-shape member in the first direction, and therefore the arrangement of the effective output light area in the first optical sheet and the second optical sheet becomes appropriate. Also, since deformation such as a wrinkle hardly occurs in the first optical sheet and the second optical sheet, unevenness hardly occurs in the output light amount from the effective output light area, and the luminance distribution of emission light is made uniform.

(9) The device includes: a third sheet member having a surface parallel to the surface of the first sheet member, stacked on a side of the second sheet member opposite to the first sheet member side, and having a coefficient of linear expansion different from at least the coefficient of linear expansion of the first sheet member; a third sheet support part which supports the one end side of the third sheet member; and a third supported part provided on the one end side of the third sheet member and close to an end with respect to a center position in the second direction and supported by the third sheet support part, the third supported part disposed at a position not superposed on the first supported part and the second supported part. With this, the third sheet member stacked on the side of the second sheet member opposite to the first sheet member side is supported in the first direction, with the third supported part provided on one end side in the first direction and close to the end with respect to the center position in the second direction being supported by the third support part. Since the third supported part is disposed at the position not superposed on the first supported part and the second supported part, even if a protrusion such as a burr is formed on the outer edge of any supported part or the opening edge of the first opening due to a reason in manufacture, the situation hardly occurs in which that protrusion is caught on the outer edge of any supported part or the opening edge of the first opening. With this, the third supported part is prevented from sticking to the first supported part and the second supported part, and each sheet member is made further less deformable.

(10) At least either one of the second sheet member and the third sheet member serves as a small-coefficient-of-linear-expansion sheet member having the coefficient of linear expansion smaller than the coefficient of linear expansion of the first sheet member, and at least either one of the second supported part and the third supported part included in the small-coefficient-of-linear-expansion sheet member forms a non-open protrusion piece shape protruding from an outer edge of the small-coefficient-of-linear-expansion sheet member along the second direction. With this, at least either of the second supported part and the third supported part included in the small-coefficient-of-linear-expansion sheet member forms protrusion piece shape protruding from the outer edge of the small-coefficient-of-linear-expansion sheet member along the second direction, and is therefore supported by at least either one of the second sheet support part and the third sheet support part even in the case of non-opening. With at least either one of the second supported part and the third supported part being made with non-opening, the size in the second direction is decreased. Since the small-coefficient-of-linear-expansion sheet member has a coefficient of linear expansion smaller than that of the first sheet member, the displacement amount in the second direction with thermal expansion regarding at least either of the second supported part and the third supported part is relatively small, compared with the displacement amount regarding the first supported part. This is suitable for making the lighting device as a narrow picture frame.

(11) The device includes: a third sheet member having a surface parallel to the surface of the first sheet member, stacked on a side of the second sheet member opposite to the first sheet member side, and having a coefficient of linear expansion different from at least the coefficient of linear expansion of the first sheet member; and a third supported part provided on the one end side of the third sheet member and at a position superposed on the first supported part, the third supported part having a third opening superposed on the first opening, the third opening which the first sheet support part passes through, and supported by the first sheet support part. With this, the third sheet member stacked on the side of the second sheet member opposite to the first sheet member side is supported in the first direction, with the third supported part provided on one end side in the first direction and at the position superposed on the first supported part being supported by the first sheet support part passing through the third opening superposed on the first opening part. Since the first supported part and the third supported part are supported by the common first sheet support part, this is suitable for simplification of the structure. Since the second sheet member is interposed between the first sheet member and the third sheet member, even if a protrusion such as a burr is formed on the opening edge of the first opening or the opening edge of the third opening due to a reason in manufacture, the situation hardly occurs in which that protrusion is caught on the third supported part or the first supported part where that protrusion is superposed.

(12) The device includes: a third sheet member having a surface parallel to the surface of the first sheet member, stacked on a side of the second sheet member opposite to the first sheet member side, and having a coefficient of linear expansion equivalent to the coefficient of linear expansion of the second sheet member; and a third supported part provided on the one end side of the third sheet member and at a position superposed on the second supported part, the third supported part supported by the second sheet support part. With this, the third sheet member stacked on the side of the second sheet member opposite to the first sheet member side is supported in the first direction, with the third supported part provided on one end side in the first direction and at the position superposed on the second supported part being supported by the second sheet support part. Since the second supported part and the third supported part being supported by the common second sheet support part, this is suitable for simplification of the structure. Since the coefficients of linear expansion of the second sheet member and the third sheet member are equivalent to each other, relative displacement with thermal expansion hardly occurs between the second supported part and the third supported part. Therefore, even if a catch occurs between the second supported part and the third supported part, deformation such as a wrinkle hardly occurs in the second sheet member and the third sheet member.

Next, to solve the above-described problem, the display device of the present invention includes the above-described lighting device and a display panel which displays an image by using light applied from the lighting device. According to the display device structured as described above, each sheet member included in the lighting device is made less deformable, and therefore display performance thus excellent.

### Advantageous Effect of the Invention

According to the present invention, each sheet member can be made less deformable.

### BRIEF DESCRIPTION OF THE DRAWINGS

FIG. 1 is an exploded perspective view depicting a schematic structure of a television receiving device according to a first embodiment of the present invention.

FIG. 2 is an exploded perspective view depicting a schematic structure of a liquid crystal display device included in the television receiving device.

FIG. 3 is a plan view of a chassis, an LED substrate, and a light guiding plate configuring a backlight device included in the liquid crystal display device.

FIG. 4 is a sectional view depicting a sectional structure of the liquid crystal display device cut along a short side direction.

FIG. 5 is a plan view of a frame and an optical sheet in a lowest temperature environment.

FIG. 6 is a plan view of the optical sheet.

FIG. 7 is a plan view of the frame.

FIG. 8 is a sectional view of FIG. 5 along an A-A line.

FIG. 9 is a sectional view of FIG. 5 along a B-B line.

FIG. 10 is a plan view of the frame and the optical sheet in a highest temperature environment.

FIG. 11 is a perspective view of an optical sheet according to a second embodiment of the present invention.

FIG. 12 is a plan view of a frame and the optical sheet in a lowest temperature environment.

FIG. 13 is a plan view of a frame and the optical sheet in a highest temperature environment.

FIG. 14 is a perspective view of an optical sheet according to a third embodiment of the present invention.

FIG. 15 is a plan view of a frame and the optical sheet in a lowest temperature environment.

FIG. 16 is a sectional view of FIG. 15 along a C-C line.

FIG. 17 is a sectional view of FIG. 15 along an A-A line.

FIG. 18 is a sectional view of FIG. 15 along a B-B line.

FIG. 19 is a sectional view of FIG. 15 along a D-D line.

FIG. 20 is a plan view of the frame and the optical sheet in a highest temperature environment.

FIG. 21 is a plan view of a frame and an optical sheet in a lowest temperature environment according to a fourth embodiment of the present invention.

FIG. 22 is a plan view of a frame and an optical sheet in a lowest temperature environment according to a fifth embodiment of the present invention.

FIG. 23 is a sectional view of FIG. 22 along an E-E line.

FIG. 24 is a perspective view of an optical sheet according to a sixth embodiment.

FIG. 25 is a sectional view of a portion near a second sheet support part cut in a liquid crystal display device.

FIG. 26 is a sectional view of a portion near a third sheet support part cut in a frame and an optical sheet.

FIG. 27 is a perspective view of an optical sheet according to a seventh embodiment.

FIG. 28 is a plan view of a frame and an optical sheet in a lowest temperature environment.

FIG. 29 is a sectional view of FIG. 28 along an F-F line.

FIG. 30 is a sectional view of FIG. 28 along an D-D line.

FIG. 31 is a perspective view of an optical sheet according to an eighth embodiment.

FIG. 32 is a plan view of a frame and an optical sheet in a lowest temperature environment.

FIG. 33 is a sectional view of FIG. 32 along a D-D line.

### BEST MODE FOR CARRYING OUT THE INVENTION

### First Embodiment

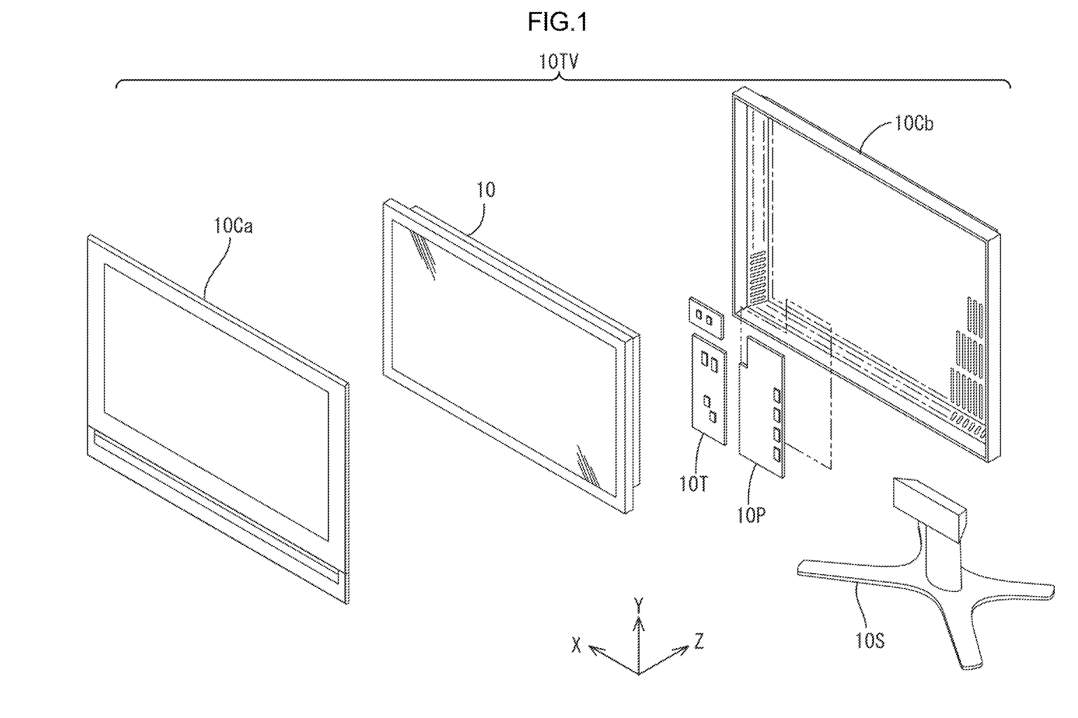

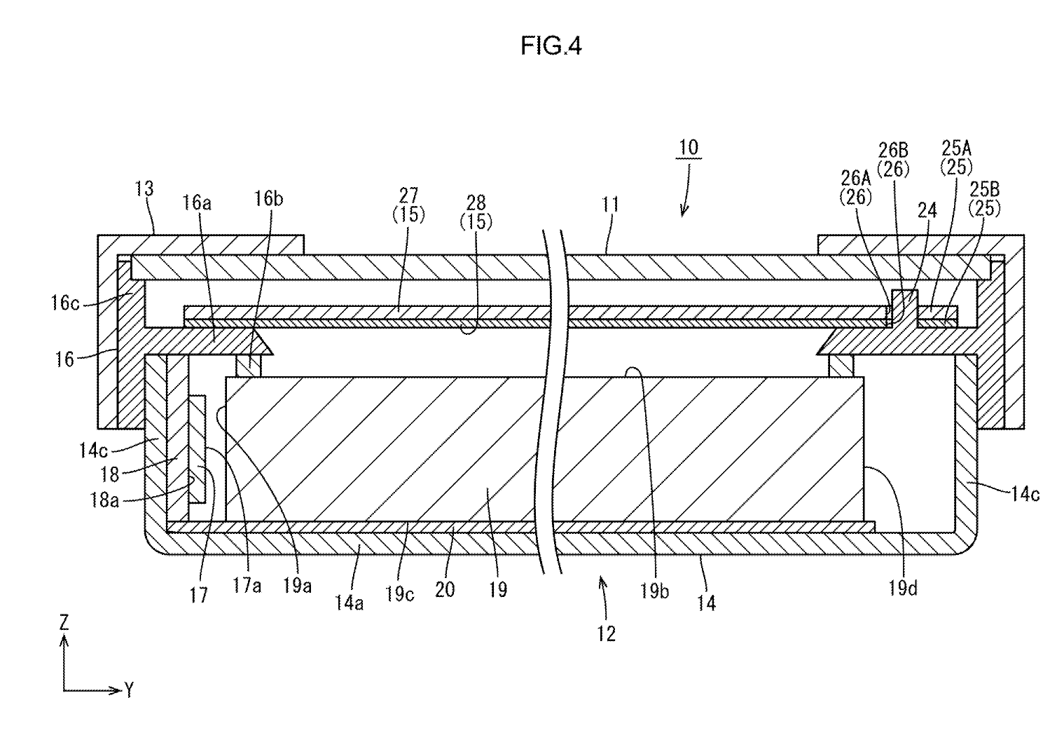

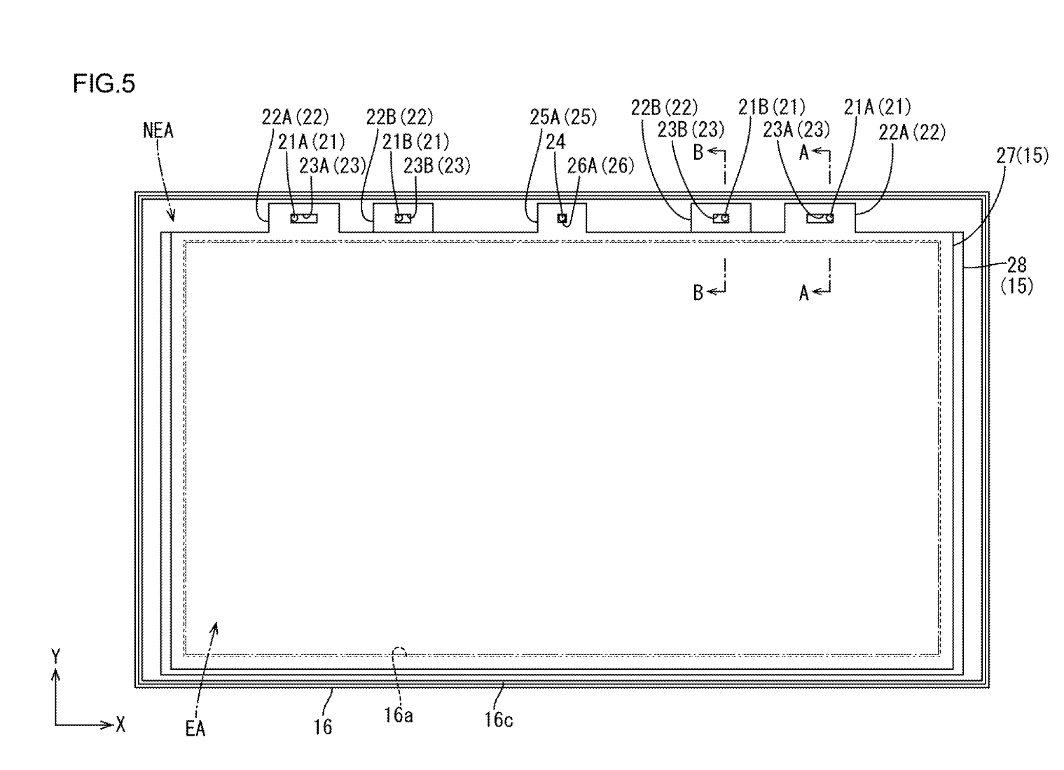

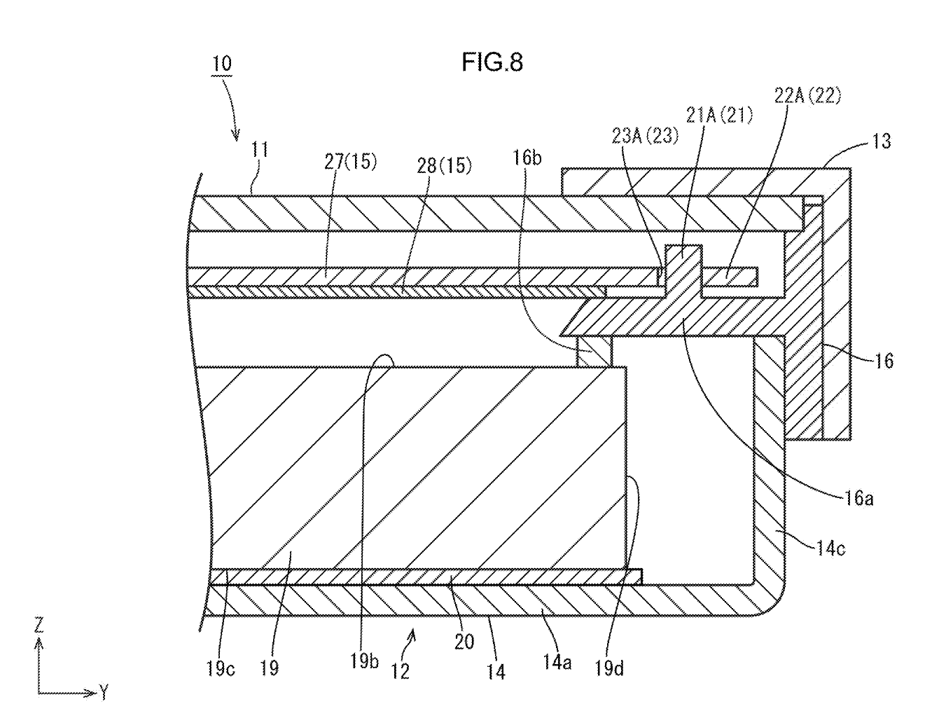

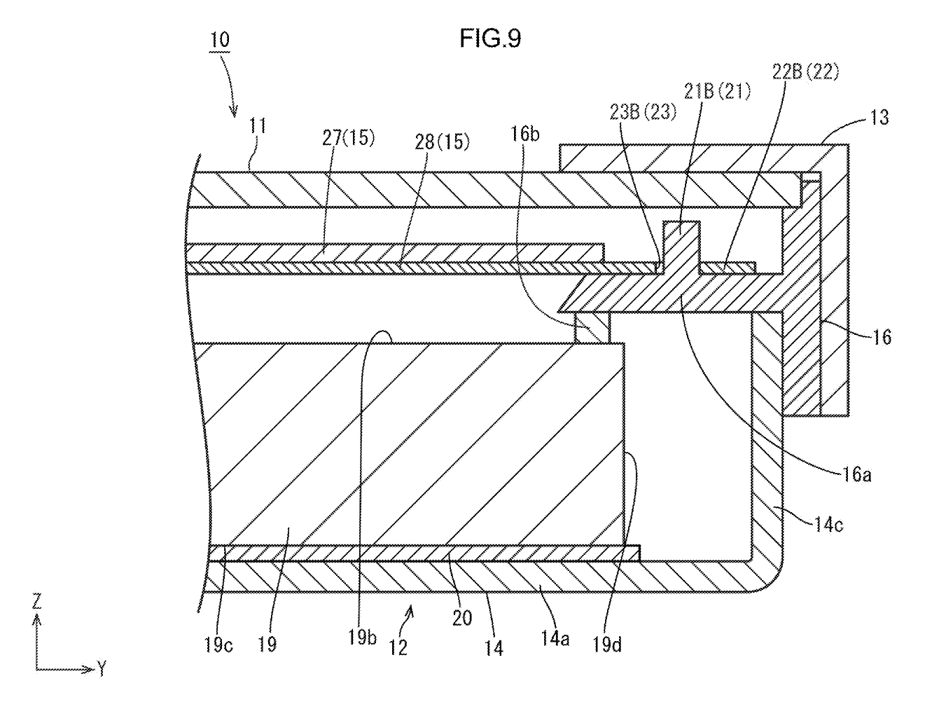

A first embodiment of the present invention is described with reference to FIG. 1 to FIG. 10. In the present embodiment, a backlight device 12 and a liquid crystal display device 10 using the same are exemplarily described. Note that an X axis, a Y axis, and a Z axis are depicted in part of each drawing and are rendered so that each axis direction is a direction indicated in each drawing. Of these, the Y axis direction substantially matches a vertical direction (first direction), and the X axis direction substantially matches a horizontal direction (second direction). Unless otherwise specified, description about upward and downward directions is made with reference to the vertical direction (such as FIG. 5 to FIG. 7). An upper side in FIG. 4, FIG. 8, and FIG. 9 is taken as a front side, a lower side therein is taken as a back side, a left side therein is taken as a lower side in the vertical direction, and a right side therein is taken as an upper side in the vertical direction.

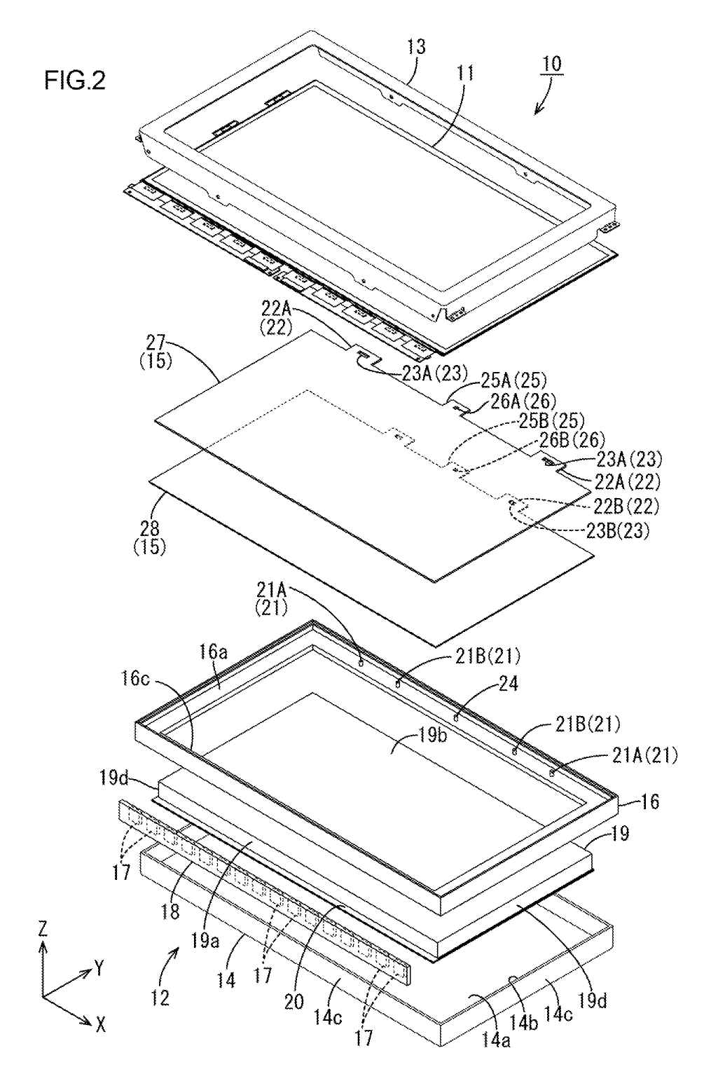

A television receiving device 10TV according to the present embodiment includes, as depicted in FIG. 1, a liquid crystal display device 10, both front and back cabinets 10Ca and 10Cb which interpose the liquid crystal display device 10 therebetween for accommodation, a power supply 10P, a tuner (receiving part) 10T which receives a television signal, and a stand 10S. The liquid crystal display device (display device) 10 forms a laterally-elongated (longitudinal) quadrate shape (rectangular shape) as a whole, and is accommodated in a vertical orientation state. This liquid crystal display device 10 includes, as depicted in FIG. 2, a liquid crystal panel (display panel) 11 which displays an image, and the backlight device (lighting device) 12 as an outer light source which supplies light for display on the liquid crystal panel 11. These are integrally held by a frame-shaped bezel 13 or the like. In the liquid crystal display device 10 according to the present embodiment, the liquid crystal panel 11 is assumed to have a screen size on the order of, for example, 60 inches to 90 inches and be classified as a large or very large type.

Next, the liquid crystal panel 11 and the backlight device 12 configuring the liquid crystal display device 10 are sequentially described. Of these, the liquid crystal panel (display panel) 11 forms a laterally-elongated quadrate shape, in a planar view, and is assumed to be configured with a pair of glass substrates laminated in a state of being separated across a predetermined gap and with a liquid crystal layer (not depicted) enclosed between both glass substrates, the liquid crystal layer containing liquid crystal molecules as substances whose optical characteristics change with the application of an electric field. On an inner surface side of one glass substrate (array substrate, active matrix substrate), switching elements (for example, TFTs) connected to source lines and gate lines orthogonal to each other and pixel electrodes disposed in a quadrate area surrounded by the source lines and the gate lines to be connected to the switching elements are arranged in a matrix shape in a planar manner. Also, an alignment layer and so forth are provided. On an inner surface side of the other glass substrate (counter substrate, CF substrate), color filters are provided, with colored parts such as R (red), G (green), and B (blue) arranged in a matrix shape with a predetermined array in a planar manner. Also, light-shielding layers (black matrixes) disposed between the colored parts to form a lattice, mat-shaped counter electrodes opposed to the pixel electrodes, an alignment layer, and so forth are provided. On an outer surface side of each of both glass substrates, a polarizing plate is disposed. Furthermore, the long side direction of the liquid crystal panel 11 matches the X axis direction, and the short side direction thereof matches the Y axis direction. Furthermore, the thickness direction matches the Z axis direction.

The backlight device 12 includes, as depicted in FIG. 2, a chassis 14 in a substantially box shape having a light emitting part 14b open outward on a front side (liquid crystal panel 11 side, output light side), an optical sheet (sheet member) 15 including multiple sheets disposed so as to cover the light emitting part 14b of the chassis 14, and a frame (frame-shaped member) 16 which receives the optical sheet 15 from a back side. Furthermore, included inside the chassis 14 are LEDs 17 as a light source, an LED substrate 18 having the LEDs 17 mounted thereon, a light guiding plate 19 which guides light from the LEDs 17 to the optical sheet 15 (liquid crystal panel 11), and a reflective sheet (reflective member) 20 laminated and arranged on a back side of the light guiding plate 19. The LED substrate 18 is disposed at one end (on a lower side in the vertical direction) of paired ends on a long-side side of this backlight device 12, and the respective LEDs 17 mounted on the LED substrate 18 are unevenly distributed to one end on the long-side side of the liquid crystal panel 11. In this manner, the backlight device 12 according to the present embodiment is assumed to be an edge light type (side light type) of a one-side light-entrance type in which light from the LEDs 17 enters the light guiding plate 19 only from one side. Next, each component of the backlight device 12 is described in detail.

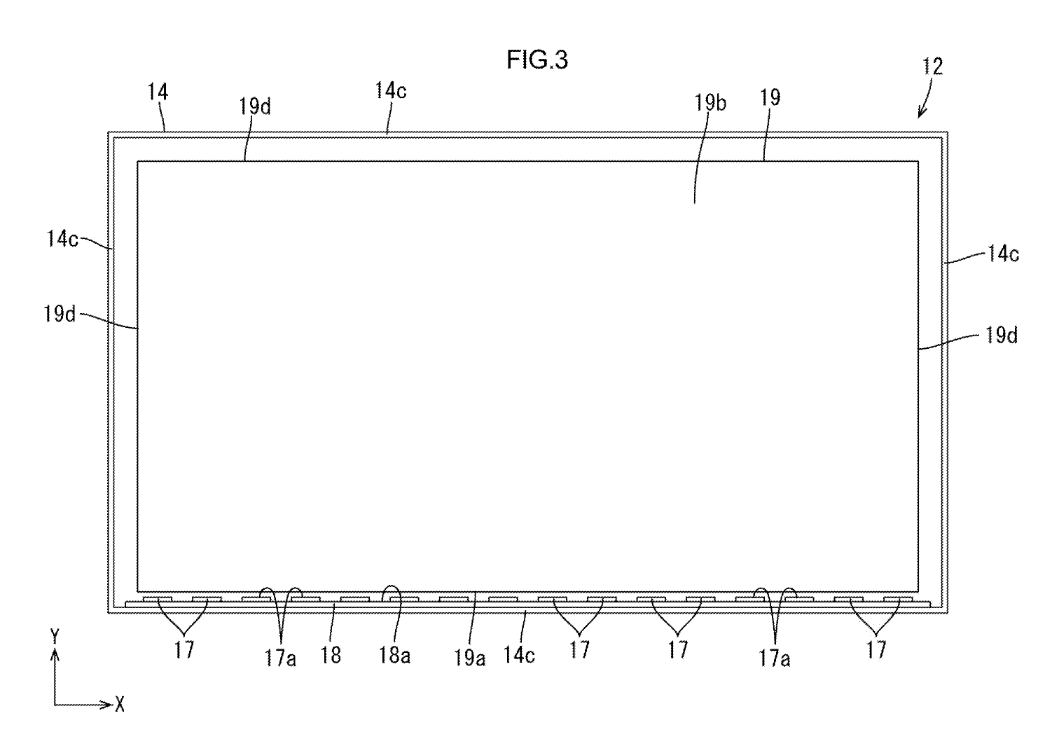

The chassis 14 is made of metal, is formed of, as depicted in FIG. 2 and FIG. 3 and as with the liquid crystal panel 11, a bottom part 14a forming a horizontally elongated quadrate shape and side parts 14c each rising from an outer end of each side of the bottom part 14a and, as a whole, is formed in a substantially box shape that is shallow and open toward a front side. In the chassis 14 (bottom part 14a), its long side direction matches the X axis direction (horizontal direction), and its short side direction matches the Y axis direction (vertical direction). To the side parts 14c, the frame 16 and the bezel 13 can be fixed.

The optical sheet 15 forms, as depicted in FIG. 2 and as with the liquid crystal panel 11 and the chassis 14, a laterally-elongated quadrate shape in a planar view, and has a plane parallel to the X axis direction (horizontal direction, second direction) and the Y axis direction (vertical direction, first direction) orthogonal to each other. The optical sheet 15 is disposed so as to cover the light emitting part 14b of the chassis 14 and be interposed between the liquid crystal panel 11 and the light guiding plate 19. That is, it can be said that the optical sheet 15 are disposed on an exit side of an output light route with respect to the LEDs 17. The optical sheet 15 is a member (optical member) that exerts an optical function of providing a predetermined optical action to light emitted from the LEDs 17 and emitting light to a liquid crystal panel 11 side. Specifically, the optical sheet 15 according to the present embodiment is configured of two sheets, that is, a reflective polarizing sheet (first sheet member, first optical sheet) 27 which polarizes and reflects light and a microlens sheet (second sheet member, second optical sheet) 28 which provides an isotropic light gathering action to light emitted from the LEDs 17. As for the optical sheet 15, as depicted in FIG. 4, the reflective polarizing sheet 27 and the microlens sheet 28 are mutually laminated in this order from a front side (output light side) and their outer edges are placed on the front side of the frame 16, which will be described further below. That is, the reflective polarizing sheet 27 and the microlens sheet 28 configuring the optical sheet 15 are opposed to the light guiding plate 19 with a space of the frame 16 (in detail, a frame-shaped part 16a, which will be described further below) on the front side.

Although detailed depiction is omitted, the reflective polarizing sheet 27 is configured of a reflective polarizing film which polarizes and reflects light and paired diffusion films (diffusion base materials) which interposes the reflective polarizing film from front and back. The reflective polarizing film of the reflective polarizing sheet 27 has a multilayer structure, for example, with layers having different refractive indexes alternately laminated, and is configured to transmit a p wave included in light and reflect an s wave to the back side. The s wave reflected by the reflective polarizing film is again reflected by a reflection sheet 20, which will be described further below, or the like to the front side and, at that time, separation is made into the s wave and the p wave. In this manner, as including the reflective polarizing film, the reflective polarizing sheet 27 can reuse the s wave, which is originally supposed to be absorbed by the polarizing plate of the liquid crystal panel 11, by reflecting the s wave to the back side (reflection sheet 20 side), and can enhance light use efficiency (and, in turn, luminance). The paired diffusion films of the reflective polarizing sheet 27 each have a plate surface opposite to a reflective polarizing film side embossed, thereby providing a diffusion action to light. The paired diffusion films are made of synthetic resin, for example, PC (polycarbonate), and have a coefficient of linear expansion of approximately 6×10⁻⁵/° C., which is larger than that of the microlens sheet 28, which will be described next. The paired diffusion film each have a thickness of 100 μm or more, which is larger compared with a reflective polarizing film having a thickness on the order of several tens of μm. Therefore, the paired diffusion films are dominant in weight and thickness in the reflective polarizing sheet 27, and also dominant in mechanical properties and thermal properties. The reflective polarizing sheet 27 has an entire thickness on the order of a range from 300 μm to 400 μm, which is thicker than that of the microlens sheet 28, which will be described next. In this manner, the reflective polarizing sheet 27 has a relatively large coefficient of linear expansion compared with the microlens sheet 28, which will be described next, and can be said as a “large-coefficient-of-linear-expansion optical sheet (large-coefficient-of-linear-expansion sheet member)”. The reflective polarizing sheet 27 is formed so that its short-side dimension (dimension in the first direction) and long-side dimension (dimension in the second direction) are smaller than the each dimension of the microlens sheet 28, and is therefore designed so that the outer shape of the reflective polarizing sheet 27 becomes equivalent to the outer shape of the microlens sheet 28 when thermally expanding at the maximum assumed. Also, compared with the microlens sheet 28, which will be described next, the reflective polarizing sheet 27 is relatively heavy and relatively thick, and can be therefore said as a “heavy optical sheet (heavy sheet member)” and a “thick optical sheet (thick sheet member) of a thick type.

Although detailed depiction is omitted, the microlens sheet 28 has a base material and a microlens part provided on a plate surface on a front side of the base material. Of these, the microlens part is configured of unit microlenses arranged in a planar manner, with many aligned in a matrix shape (array shape) along the X axis direction and the Y axis direction. The unit microlenses form a substantially circular shape in a planar view, and are formed as a convex lens forming a substantially semi-spherical shape as a whole. With the structure as described above, the microlens sheet 28 isotropically provides light with a light gathering action (isotropic light gathering action) in the X axis direction and the Y axis direction. The base material of the microlens sheet 28 is made of synthetic resin, for example, PET (polyethylene terephthalate), and its coefficient of linear expansion is approximately 2 to 3×10⁻⁵/° C., which is smaller than that of the reflective polarizing sheet 27 described above. As for the base material, its thickness is assumed to be on the order of a range from 100 μm to 300 μm, preferably on the order of 200 μm. As for the microlens part, its thickness is assumed to be on the order of a range from 30 μm to 40 μm. Therefore, the base material is dominant in weight and thickness in the microlens sheet 28, and also dominant in mechanical properties and thermal properties. The microlens sheet 28 has an entire thickness on the order of a range from 130 μm to 340 μm, preferably on the order of 250 μm, which is thinner than that of the reflective polarizing sheet 27. In this manner, the microlens sheet 28 has a relatively small coefficient of linear expansion compared with the above-described reflective polarizing sheet 27, and can thus be said as a “small-coefficient-of-linear-expansion optical sheet (small-coefficient-of-linear-expansion sheet member)”. The microlens sheet 28 is formed so that its short-side dimension (dimension in the first direction) and long-side dimension (dimension in the second direction) are larger than each dimension of the reflective polarizing sheet 27, and is therefore designed so that the outer shape of the microlens sheet 28 becomes equivalent to the outer shape of the reflective polarizing sheet 27 when thermally expanding at the maximum assumed. Compared with the reflective polarizing sheet 27 described above, the microlens sheet 28 has a relatively light weight and is relatively thin, and can be therefore said as a “light-weight optical sheet (light-weight sheet member)” and a “thin optical sheet (thin sheet member) of a thin type. Since this microlens sheet 28 is a “thin sheet member”, compared with the reflective polarizing sheet 27 as a “thick sheet member”, deformation such as a warp or wrinkle intrinsically tends to occur. However, the microlens sheet 28 is disposed so as to be stacked on the back side of the reflective polarizing sheet 27, that is, a side opposite to the output light side. Therefore, even in the event that deformation such as a warp or wrinkle occurs in the microlens sheet 28, that deformation is less visually recognized from a user of the backlight device 12.

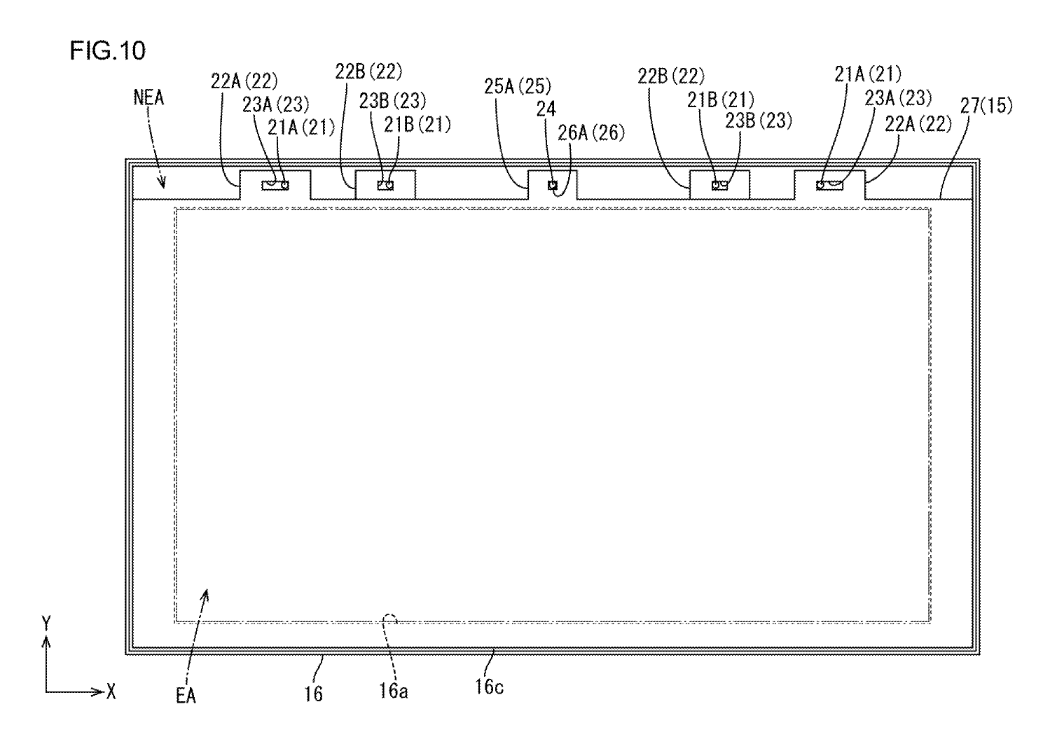

The frame 16 has the laterally-elongated frame-shaped part (picture-frame-shaped part, frame-shaped support part) 16a extending along the outer edge of the light guiding plate 19 and the optical sheet 15 as depicted in FIG. 2, and is assumed to press the outer edge of the light guiding plate 19 by its frame-shaped part 16a from the front side over an approximately entire perimeter. The frame-shaped part 16a of the frame 16 is interposed between the optical sheet 15 and the light guiding plate 19, and receives the outer edge of the optical sheet 15 from the back side, thereby being kept at a position with a space of the frame-shaped part 16a between the optical sheet 15 and the light guiding plate 19. On a surface on the back side (the light guiding plate 19 side) of the frame-shaped part 16a of the frame 16, a cushioning material 16b made of, for example, PORON (registered trademark), is provided. The cushioning material 16b forms a frame shape so as to extend over the entire perimeter of the frame-shaped part 16a. The frame-shaped part 16a of the frame 16 is provided with a sheet receiving part 16c capable of receiving a lower end of the optical sheet 15 in the vertical direction. The sheet receiving part 16c has a space between itself and the lower end of the optical sheet 15 in the vertical direction in a relatively low temperature environment, but makes contact with the lower end of the thermally-expanded optical sheet 15 in the vertical direction in a relatively high temperature environment (refer to FIG. 10). The sheet receiving part 16c extends to the lower long side as well as the paired short sides and the upper long side of the frame-shaped part 16a in the vertical direction, and forms a frame shape extending over the entire perimeter of the frame-shaped part 16a as a whole. The sheet receiving part 16c is disposed on the outer edge of the frame-shaped part 16a and is provided so as to protrude from the frame-shaped part 16a toward the front side, and has a protrusion tip, which allows the outer edge of the liquid crystal panel 11 to be received from the back side (refer to FIG. 4).

The LEDs 17 are of a so-called top-emitting type in which they are surfaced-mounted on the LED substrate 18 and its light-emitting surface 17a is oriented toward a side opposite to an LED substrate 18 side, as depicted in FIG. 3 and FIG. 4. In the LEDs 17, LED chips perform monochromatic light emission of, for example, blue light. With phosphors (such as yellow phosphors, green phosphors, and red phosphors) distributed and incorporated into a sealing material, the LEDs 17 emit white light as a whole.

The LED substrate 18 forms a narrowly-elongated plate shape extending along the long side direction (X axis direction) of the chassis 14 and, is disposed in the chassis 14 so that a mount surface 18a where the LEDs 17 are mounted is opposed to an end face of the light guiding plate 19, as depicted in FIG. 3 and FIG. 4. In the LED substrate 18, a plate surface opposite to the mount surface 18a of the LEDs 17 is attached to the chassis 14 so as to make contact with the inner surface of the lower side part 14c in the vertical direction. On the mount surface 18a of the LEDs 17 in the LED substrate 18, a wiring pattern (not depicted) for feeding power to the LEDs 17 is subjected to patterning, and is mounted so that the plurality of LEDs 17 are aligned with a space along the X axis direction.

The light guiding plate 19 is made of a synthetic resin material which is approximately transparent and has an index of refraction sufficiently higher than that of air (for example, such as acrylic resin such as PMMA or polycarbonate). As depicted in FIG. 2 and FIG. 4, the light guiding plate 19 is accommodated inside the chassis 14 so as to be oriented with its plate surface parallel to the plate surfaces of the liquid crystal panel 11 and the optical sheet 15 and disposed at a position straight below the liquid crystal panel 11 and the optical sheet 15. As depicted in FIG. 3, the light guiding plate 19 forms a plate shape with a thickness larger than that of the optical sheet 15 and a laterally-elongated quadrate shape in a planar view, and circumferential end faces are configured of paired short-side end faces and paired long-side end faces orthogonal to one another. In the light guiding plate 19, of the circumferential end faces, while the long-side end face positioned on a lower side in the vertical direction serves as an incident-light end face (light-source-opposed end face) 19a which is opposed to the LEDs 17 and light from the LEDs 17 directly enters, the remaining three end faces (the other long-side end face and the paired short-side end faces) each serve as a non-incident-light end face (light-source-unopposed end face) 19d which is not opposed to the LEDs 17 and light from the LEDs 17 does not directly enter. In the light guiding plate 19, of the paired front and back plate surfaces, the plate surface oriented to the front side (liquid crystal panel 11 side, optical sheet 15 side) serves as an output-light plate surface 19b from which light is emitted toward the liquid crystal panel 11 and the optical sheet 15, and the plate surface oriented to the back side servers as an output-light opposite plate surface 19c opposite to the output-light plate surface 19b. With the structure as described above, the light guiding plate 19 has a function of introducing, from the incident-light end face 19a, light emitted from the LEDs 17 along the Y axis direction, propagating the light inside, and then raising the light along the Z axis direction to emit the light from the output-light plate surface 19b toward the optical sheet 15 side (front side, light emission side).

In the optical sheet 15 and the light guiding plate 19 as optical members which provide optical action to transmitted light in the backlight device 12 according to the present embodiment, as depicted in FIG. 5, a center side portion serves as an effective light output light area EA. By contrast, an outer peripheral end side portion surrounding the effective output light area EA serves as a non-effective output light area NEA incapable of effectively emitting light. A boundary position between these effective output light area EA and non-effective output light area NEA substantially matches the inner edge of the frame-shaped part 16a of the frame 16, and also substantially matches a boundary position on the liquid crystal panel 11 between a display area for displaying an image and a non-display area where no image is displayed. That is, it can be said that the frame 16 delimits the effective output line area EA of the optical sheet 15 and the light guiding plate 19. In FIG. 5 and FIG. 10, the boundary position between the effective output light area EA and the non-effective output light area NEA is indicated by a one-dot chain line.

The reflective sheet 20 has its plate surface parallel to the plate surface of the light guiding plate 19 and so forth and is disposed so as to cover the output-light opposite plate surface 19c of the light guiding plate 19, as depicted in FIG. 4. The reflective sheet 20 is excellent in light reflection, and can efficiently raise light leaked from the output-light opposite plate surface 19c of the light guiding plate 19 toward the front side (output-light plate surface 19b). The reflective sheet 20 has an outer shape next larger than that of the light guiding plate 19, and is disposed so that a long-side end positioned on a lower side in the vertical direction protrudes to an LEDs 17 side rather than the incident-light end face 19a.

The backlight device 12 according to the present embodiment has a sheet support structure (sheet suspension structure) of supporting (suspending) the optical sheet 15 in the vertical direction (Y axis direction, first direction) while allowing thermal expansion or thermal contraction of the optical sheet 15, as depicted in FIG. 2 and FIG. 5. The sheet support structure includes sheet support parts 21 which support an upper end side (one end side, side opposite to the LEDs 17 side) of the optical sheet 15 in the vertical direction and supported parts 22 provided to an upper end of the optical sheet 15 in the vertical direction, having openings 23 which the sheet support parts 21 pass through, and supported by the sheet support parts 21 passing through the openings 23. This sheet support structure includes one which individually supports the reflective polarizing sheet 27 and the microlens sheet 28 having coefficients of linear expansion that are different from each other. That is, the sheet support structure includes a first sheet support structure which supports the reflective polarizing sheet 27 and a second sheet support structure which supports the microlens sheet 28.

The first sheet support structure includes paired first sheet support parts 21A which support an upper end side of the reflective polarizing sheet 27 in the vertical direction and paired first supported parts 22A provided to an upper end of the reflective polarizing sheet 27 in the vertical direction, having first openings 23A which the first sheet support parts 21A pass through, and supported by the first sheet support parts 21A passing through the first openings 23A, as depicted in FIG. 2, FIG. 5, and FIG. 8. The second sheet support structure includes paired second sheet support parts 21B which support an upper end side of the microlens sheet 28 in the vertical direction and paired second supported parts 22B provided to an upper end of the microlens sheet 28, having second openings 23B which the second sheet support parts 21B pass through, and supported by the second sheet support parts 21B passing through the second openings 23B, as depicted in FIG. 2, FIG. 5, and FIG. 9, and has a feature in which, of these, the second supported parts 22B are disposed at positions not overlapping at least the first openings 23A regarding the first sheet support structure in a planar view.

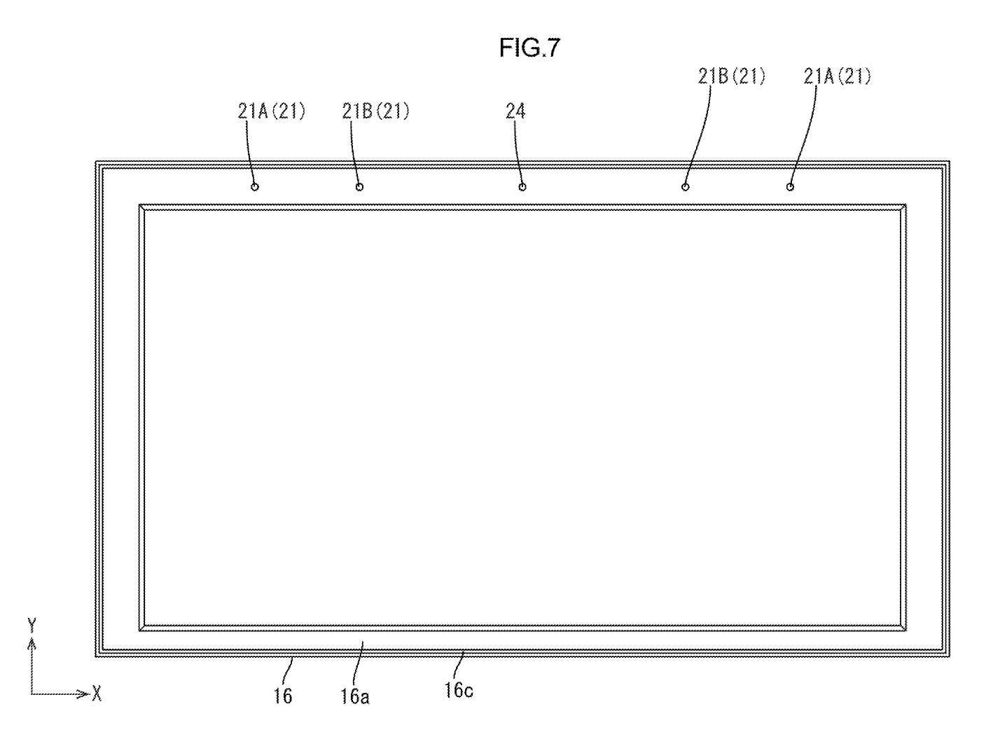

The sheet support parts 21 is described in detail. The first sheet support parts 21A and the second sheet support parts 21B are provided so as to be integrated with the frame 16, as depicted in FIG. 2, FIG. 5, and FIG. 7. Since the frame 16 delimits the effective output light area EA in the reflective polarizing sheet 27 and the microlens sheet 28, with the first sheet support parts 21A and the second sheet support parts 21B integrally provided to that frame 16, the in-plane arrangement of the effective output light area EA in the reflective polarizing sheet 27 and the microlens sheet 28 becomes appropriate. In detail, the first sheet support parts 21A and the second sheet support parts 21B are each provided to the upper long side of the frame-shaped part 16a of the frame 16 in the vertical direction, and are each arranged so as to be close to an end with respect to the center position of that long side in the horizontal direction (second direction). The first sheet support parts 21A are disposed so as to be closer to the ends in the horizontal direction than the second sheet support parts 21B and, specifically, are disposed in one pair, each at a position close to the center by a distance on the order of approximately one quarter of the long-side dimension of the frame 16 from each of both end positions of the frame 16 in the long-side direction. The second sheet support parts 21B are disposed so as to be closer to the center in the horizontal direction than the first sheet support parts 21A and, specifically, are disposed in one pair, each at a position close to the center by a distance on the order of approximately one thirds of the long-side dimension of the frame 16 from each of both end positions of the frame 16 in the long-side direction. The first sheet support parts 21A in one pair and the second sheet support parts 21B in one pair are provided at positions symmetrical to the center position of the upper long side of the frame-shaped part 16a in the horizontal direction. The first sheet support parts 21A in one pair and the second sheet support parts 21B each form a circular rod shape (columnar shape) in a planar view so as to protrude from the frame-shaped part 16a toward the front side.

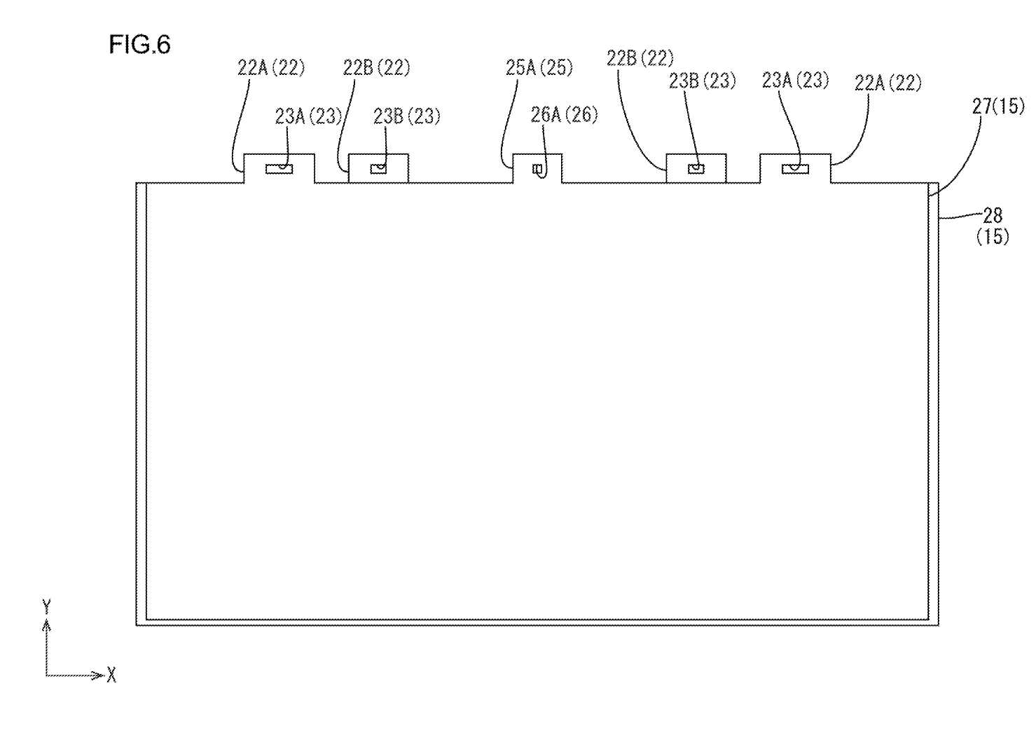

The supported parts 22 is described in detail. As depicted in FIG. 6, the first supported parts 22A and the second supported parts 22B each form a protrusion piece shape protruding partially upward from an upper edge of the outer edge of the reflective polarizing sheet 27 and the microlens sheet 28 in the vertical direction and, specifically, for example, a laterally-elongated quadrate shape in a planar view. According to the structure as described above, for example, compared with the case in which the entire length of the reflective polarizing sheet and the microlens sheet upward in the vertical direction to form each of the first supported parts and the second supported parts, material cost regarding the reflective polarizing sheet 27 and the microlens sheet 28 can be reduced. The first supported parts and the second supported parts are each arranged so as to be close to to an end with respect to the center position of the upper end side (other end side) of the reflective polarizing sheet 27 and the microlens sheet 28 in the horizontal direction. The first supported parts 22A are disposed so as to be closer to the ends in the horizontal direction than the second supported parts 22B and, specifically, are disposed in one pair, each at a position close to the center by a distance on the order of approximately one quarter of the long-side dimension of the reflective polarizing sheet 27 from each of both end positions of the reflective polarizing sheet 27 in the long-side direction. The second supported parts 22B are disposed so as to be closer to the center in the horizontal direction than the first supported parts 22A and, specifically, are disposed in one pair, each at a position close to the center by a distance on the order of approximately one thirds of the long-side dimension of the microlens sheet 28 from each of both end positions of the microlens sheet 28 in the long-side direction. The first supported parts 22A in one pair and the second supported parts 22B in one pair are provided at positions symmetrical to the center position of the upper end side of the reflective polarizing sheet 27 and the microlens sheet 28 in the horizontal direction.

The first supported parts 22A and the second supported parts 22B each have formed therein a first opening 23A and a second opening 23B, respectively, forming a hole shape penetrating along its thickness direction (Z axis direction), as depicted in FIG. 6. Therefore, the outer dimension of each of the first supported parts 22A and the second supported parts 22B are set larger than the outer dimension of the first opening 23A and the second opening 23B, respectively. Since the first supported parts 22A and the second supported parts 22B each serve as a support starting point to be suspended by the first sheet support part 21A and the second sheet support part 21B, respectively, as depicted in FIG. 5, when the reflective polarizing sheet 27 and the microlens sheet 28 thermally expand, the first supported parts 22A and the second supported parts 22B are displaced only along the horizontal direction and are hardly displaced in the vertical direction. Therefore, the first openings 23A and the second openings 23B are provided so as to linearly extend along the horizontal direction, which is a displacement direction of the first supported parts 22A and the second supported parts 22B, and each have a length dimension (dimension regarding the horizontal direction) larger than the outer dimension (diameter dimension) of the first sheet support part 21A and the second sheet support part 21B, respectively. With this, as the reflective polarizing sheet 27 and the microlens sheet 28 thermally expand, the first supported parts 22A and the second supported parts 22B can be relatively displaced along the horizontal direction with respect to the first sheet support parts 21A and the second sheet support parts 21B, respectively. The length dimension of the first opening 23A and the length dimension of the second opening 23B are set so as to be substantially equal to a maximum displacement amount of the first supported part 22A and a maximum displacement amount of the second supported part 22B, respectively, assumed when the reflective polarizing sheet 27 and the microlens sheet 28 thermally expand. Therefore, while the first sheet support part 21A and the second sheet support part 21B are disposed at the end positions in the first opening 23A and the second opening 23B on the center side in the horizontal direction of the reflective polarizing sheet 27 and the microlens sheet 28 in an assumed lowest temperature environment, as the lowest temperature environment becomes at high temperature, the first sheet support part 21A and the second sheet support part 21B are relatively displaced in the first opening 23A and the second opening 23B to the end side in the horizontal direction, and are disposed at an end position on the end side in the horizontal direction in the first opening 23A and the second opening 23B (refer to FIG. 10). The first opening 23A and the second opening 23B have an opening width (dimension regarding the vertical direction) substantially equal to the outer dimension of the first sheet support part 21A and the second sheet support part 21B, respectively. Therefore, the opening edge of the first opening 23A and the second opening 23B make contact with the first sheet support part 21A and the second sheet support part 21B, respectively, by catching the relevant sheet support part from above and below in the vertical direction, and guide the first supported parts 22A and the second supported parts 22B to the operation of relative displacement along the horizontal direction.

As described above, since the reflective polarizing sheet 27 and the microlens sheet 28 depicted in FIG. 6 have coefficients of linear expansion that are different from each other, the displacement amounts of the first supported parts 22A and the second supported parts 22B in the horizontal direction at the time of thermal expansion are different from each other and, due to this, the first supported parts 22A and the second supported parts 22B are relatively displaced along the horizontal direction. Specifically, since the reflective polarizing sheet 27 has a relatively large coefficient of linear expansion, the displacement amount of the first supported parts 22A in the horizontal direction at the time of thermal expansion is relatively large. On the other hand, since the microlens sheet 28 has a relatively small coefficient of linear expansion, the displacement amount of the second supported parts 22B in the horizontal direction at the time of thermal expansion is relatively small. In particular, since the first supported parts 22A of the reflective polarizing sheet 27 with the large coefficient of linear expansion are each disposed close to the end in the horizontal direction with respect to the second supported parts 22B, and the displacement amount in the horizontal direction at the time of thermal expansion is larger. Conversely, since the second supported parts 22B of the microlens sheet 28 with the small coefficient of linear expansion are disposed close to the center in the horizontal direction with respect to the first supported parts 22A, the displacement amount in the horizontal direction at the time of thermal expansion is smaller. That is, in addition to the difference in coefficient of linear expansion between the reflective polarizing sheet 27 and the microlens sheet 28, the arrangement of the first supported parts 22A and the second supported parts 22B in the horizontal direction synergistically increases relative displacement amounts of the first supported parts 22A and the second supported parts 22B at the time of thermal expansion.

For manufacture, the reflective polarizing sheet 27 and the microlens sheet 28 are each formed into a desired shape by, for example, punching a large sheet parent material along its thickness direction with a blade. Of the reflective polarizing sheet 27 and the microlens sheet 28, at a location where the blade makes contact in the above-described punching, a protrusion such as a burr protruding along the thickness direction (punching direction) may be formed with the above-described punching. In particular, a protrusion such as a burr tends to occur at a location where the outer shape processed by a blade is complex and small. Of the reflective polarizing sheet 27 and the microlens sheet 28, the first supported parts 22A and the second supported parts 22 have relatively complex shapes, and therefore a protrusion such as a burr tends to occur. Among others, the opening edges of the first openings 23A and the second openings 23B are complex and small, and therefore a protrusion such as a burr tends to occur more. Here, if a structure is taken in which the first supported parts and the second supported parts are disposed so as to be superposed in a planar view and supported by common support parts, a protrusion such as a burr occurring at the opening edge of any first opening or the opening edge of any second opening may be caught on the counterpart. If so, the first supported part and the second supported part may stick to each other to inhibit relative displacement at the time of thermal expansion, and there is a possibility of occurrence of deformation such as a wrinkle in the reflective polarizing sheet or the microlens sheet. This deformation that can occur in the reflective polarizing sheet or the microlens sheet tends to become worse as the relative displacement amounts of the first supported parts and the second supported parts at the time of thermal expansion are increased.

In this respect, the second supported parts 22B according to the present embodiment are disposed at positions not superposed on at least the first openings 23A in a planar view, and the first supported parts 22A are disposed at positions not superposed on at least the second openings 23B in a planar view, as depicted in FIG. 5 and FIG. 9. Therefore, even if a protrusion such as a burr is formed on the opening edge of any first opening 23A or the opening edge of any second opening 23B, the situation hardly occurs in which that protrusion is caught on the second supported part 22B or the first supported part 22A. With this, the first supported part 22A and the second supported part 22B hardly stick to each other. Therefore, even if the displacement amount of the first supported parts 22A in the horizontal direction with thermal expansion is different from that of the second supported parts 22B, relative displacement of the first supported parts 22A and the second supported parts 22B is allowed. Thus, deformation such as a wrinkle hardly occurs in the reflective polarizing sheet 27 and the microlens sheet 28, and therefore a luminance distribution regarding light emitted from the effective output light area EA in the reflective polarizing sheet 27 and the microlens sheet 28 is made uniform. Also, according to the above-described structure, since the first openings 23A and the second openings 23B are arranged so as not to be superposed each other in a planar view, when a protrusion such as a burr is formed at the opening edge of any first opening 23A, the situation hardly occurs in which that protrusion is caught on the opening edge of the second opening 23B. Conversely, when a protrusion such as a burr is formed at the opening edge of any second opening 23B, the situation hardly occurs in which that protrusion is caught on the opening edge of the first opening 23A. With this, the first supported part 22A and the second supported part 22B hardly stick to each other, and the reflective polarizing sheet 27 and the microlens sheet 28 are made further less deformable.

Furthermore, the second supported parts 22B is positionally displaced with respect to the first supported parts 22A in the horizontal direction, and are arranged so as not to be superposed in a planar view, as depicted in FIG. 5. With the structure as described above, even if a protrusion such as a burr is formed on the outer edge of any first supported part 22A, the situation hardly occurs in which that protrusion is caught on the outer edge of the second supported part 22B or the opening edge of the second opening 23B. Also, even if a protrusion such as a burr is formed on the outer edge of any second supported part 22B, the situation hardly occurs in which that protrusion is caught on the outer edge of the first supported part 22B or the opening edge of the first opening 23A. With this, the first supported parts 22A and the second supported parts 23B are prevented from sticking to each other, and the reflective polarizing sheet 27 and the microlens sheet 28 are made further less deformable.

The above-described sheet support structure is disposed close to ends with respect to the center position of the optical sheet 15 in the horizontal direction, as depicted in FIG. 2 and FIG. 5. By contrast, a center-side sheet support structure, which will be described next, is disposed at the center position of the optical sheet 15 in the horizontal direction to support the optical sheet 15 in the vertical direction. The center-side sheet support structure includes, as depicted in FIG. 5, a center-side sheet support part 24 which supports an upper end side of the optical sheet 15 in the vertical direction on a center side in the horizontal direction and a center-side supported part 25 provided at an upper end in the vertical direction and a center position in the horizontal direction of the optical sheet 15, having a center-side opening 26 which the center-side sheet support part 24 passes through, and supported by the center-side sheet support part 21 passing through the center-side opening 26. Of these, the center-side sheet support part 24 is provided so as to form a columnar shape protruding from the upper long side of the frame-shaped part 16a of the frame 16 in the vertical direction toward the front side, and is arranged at the center position of that long side in the horizontal direction. Therefore, a distance from the center-side sheet support part 24 to each sheet support part 21 is substantially equal. This center-side sheet support part 24 collectively supports the reflective polarizing sheet 27 and the microlens sheet 28, and is shared in common between the reflective polarizing sheet 27 and the microlens sheet 28.

The center-side supported part 25 forms a protrusion piece shape protruding partially upward, that is, to the same orientation as each supported part 22, from an upper edge of the outer edge of the optical sheet 15 in the vertical direction, as depicted in FIG. 4 and FIG. 5. With the structure as described above, by using the arrangement space of the center-side supported part 25, each supported part 22 can be arranged. Therefore, compared with the case in which the supported part protrudes from the outer edge of the optical sheet 15 along the horizontal direction, the size of the optical sheet 15 can be decreased in the horizontal direction. Specifically, for example, the center-side supported part 25 forms a laterally-elongated quadrate shape in a planar view. The center-side supported part 25 is arranged at the center position in the horizontal direction on the upper end side of the optical sheet 15. Therefore, a distance from the center-side supported part 25 to each supported part 22 is substantially equal. The above-structured center-side supported part 25 includes a first center-side supported part 25A provided to the reflective polarizing sheet 27 and a second center-side supported part 25B provided to the microlens sheet 28. These first center-side supported part 25A and second center-side supported part 25B are arranged so as to be superposed each other in a planar view.

The center-side supported part 25 has the center-side opening 26 which the center-side sheet support part 24 passes through formed in a hole shape penetrating through the center-side supported part 25 along its thickness direction, as depicted in FIG. 4 and FIG. 5. This center-side opening 26 forms a square shape in a planar view, with its opening width substantially equal to or approximately slightly larger than the outer shape of the center-side sheet support part 24. The above-structured center-side opening 26 includes a first center-side opening 26A provided in the first center-side supported part 25A and a second center-side opening 26B provided in the second center-side supported part 25B. These first center-side opening 26A and second center-side opening 26B are arranged so as to be superposed each other in a planar view. With the structure as described above, with the common center-side sheet support part 24 passing through the first center-side opening 26A and the second center-side opening 26B superposed each other, the reflective polarizing sheet 27 and the microlens sheet 28 are supported on the center side in the horizontal direction. With the center-side sheet support part 24 shared in common as described above, the structure is simplified. The first center-side supported part 25A and the second center-side supported part 25B are portions serving as origins when the reflective polarizing sheet 27 and the microlens sheet 28 extend along the horizontal direction at the time of thermal expansion, therefore hardly make relative displacement with thermal expansion in the horizontal direction with respect to the center-side sheet support part 24, and are thus prevented from causing deformation such as a wrinkle in the reflective polarizing sheet 27 and the microlens sheet 28.

The present embodiment has the structure as described above, and its operation is described next. When the above-structured liquid crystal display device 10 is powered ON, driving of the liquid crystal panel 11 is controlled by a control circuit not depicted, and driving power from an LED driving circuit not depicted is supplied to each LED 17 of the LED substrate 18, thereby controlling the driving. As depicted in FIG. 4, light from each LED 17 is guided by the light guiding plate 19 to be applied to the liquid crystal panel 11 via the optical sheet 15, thereby causing a predetermined image to be displayed on the liquid crystal panel 11.

When each LED 17 is lit up with the use of the liquid crystal display device 10, each LED 17 generates heat, and various substrates disposed on the back side of the backlight device 12 also generate heat. Other than that, the external environment temperature (room temperature in the case of indoor use, outdoor temperature in the case of outdoor use) may be increased. When the temperature environment is increased, the components of the liquid crystal display device 10 may thermally expand. In particular, the extension amount of the optical sheet 15, which are large and thin optical members, with thermal expansion tends to increase, deformation such as a wrinkle or warp with expansion tends to occur, and optical performance tends to deteriorate. Due to these circumstances, the present embodiment adopts, for example, a sheet support structure which supports the optical sheet 15 in the vertical direction while allowing thermal expansion of the optical sheet 15, and its operation is described below in detail.

First, the temperature environment of the backlight device 12 fluctuates in accordance with the external environment temperature and the use situation of the liquid crystal display device 10. While a lowest temperature environment is such that a state is assumed in which the backlight device 12 is not lit up at a low external environment temperature, a highest temperature environment is such that a state is assumed in which the backlight device 12 is lit up with maximum luminance at a high external environment temperature. FIG. 5 depicts the lowest temperature environment, and FIG. 10 depicts the highest temperature environment.

For example, when the use of the liquid crystal display device 10 is started in the lowest temperature environment depicted in FIG. 5 to light up the backlight device 12, the internal temperature of the liquid crystal display device 10 increases due to heat generated from the LEDs 17 and so forth, and therefore the optical sheet 15 thermally expand. Other than that, even if the liquid crystal display device 10 is not used in the lowest temperature environment, if the external environment temperature increases, the internal temperature of the liquid crystal display device 10 also increases, and the optical sheet 15 thermally expand. In any event, when the temperature is increased from the lowest temperature environment, the optical sheet 15 thermally expand from the state depicted in FIG. 5 to extend along each of the vertical direction and the horizontal direction. Here, by taking each supported part 22 and the center-side supported part 25 (upper end side) supported by each sheet support part 21 and the center-side sheet support part 24 as origins, a lower end of the optical sheet 15 in the vertical direction extends downward to approach the sheet receiving part 16c. Also, by taking the center-side supported part 25 supported by the center-side sheet support part 24 as an origin, both side ends of the optical sheet 15 in the horizontal direction each extending in a lateral orientation. When the optical sheet 15 extends along the horizontal direction, each supported part 22 disposed closer to the end than the center position in the horizontal direction is also displaced accordingly so as to go away from the center position along the horizontal direction. Here, each sheet support part 21 is relatively displaced along the horizontal direction from the end side toward the center side of the optical sheet 15 in the horizontal direction, in each opening 23 of each supported part 22.

In detail, since the coefficient of linear expansion of the reflective polarizing sheet 27 is larger than that of the microlens sheet 28 and the arrangement of the first supported parts 22A in the horizontal direction is closer to the ends than the second supported parts 22B as depicted in FIG. 5, the displacement amount of the first supported parts 22A displaced along the horizontal direction with thermal expansion of the reflective polarizing sheet 27 is relatively large. By contrast, since the coefficient of linear expansion of the microlens sheet 28 is smaller than that of the reflective polarizing sheet 27 and the arrangement of the second supported parts 22B in the horizontal direction is closer to the center than the first supported parts 22A, the displacement amount of the second supported parts 22B displaced along the horizontal direction with thermal expansion of the microlens sheet 28 is relatively small. Therefore, as thermal expansion of the reflective polarizing sheet 27 and the microlens sheet 28 proceeds, the first supported parts 22A and the second supported parts 22B are relatively displaced in the horizontal direction, and a distance of a space therebetween in the horizontal direction is gradually widened.

The first supported parts 22A and the second supported parts 22B which are relatively displaced in the horizontal direction in this manner are arranged so as not to be superposed each other in a planar view as depicted in FIG. 5. Therefore, even if a protrusion as a burr is formed on the opening edge of any first opening 23A, the opening edge of any second opening 23B, the outer edge of any first supported part 22A, and the outer edge of any second supported part 22B, the situation hardly occurs in which that protrusion is caught on the counterpart, and the first supported parts 22A and the second supported parts 23B are prevented from sticking to each other and the operation of relative displacement of both is prevented from being inhibited. With this, it is secured that as thermal expansion of the reflective polarizing sheet 27 and the microlens sheet 28 proceeds, the first supported parts 22A and the second supported parts 22B are displaced mutually independently and freely along the horizontal direction. Therefore, the reflective polarizing sheet 27 and the microlens sheet 28 are made further less deformable such as a wrinkle.

As the external environment temperature increases and the backlight device 12 is lit up with the maximum luminance, the environment becomes the highest temperature environment. When the environment reaches the highest temperature environment, as depicted in FIG. 10, each supported part 22 is disposed most close to the end of the optical sheet 15 in the horizontal direction, and each sheet support part 21 is disposed in each opening 23 at an end position on the center side of the optical sheet 15 in the horizontal direction. The optical sheet 15 has the lower end received by the sheet receiving part 16c.

As described above, the backlight device (lighting device) 12 of the present embodiment includes: the reflective polarizing sheet (first sheet member) 27 having a surface parallel to a first direction and a second direction orthogonal to each other; the first sheet support part 21A which supports one end side of the reflective polarizing sheet 27 in the first direction; the first supported part 22A provided on the one end side of the reflective polarizing sheet 27 and close to an end with respect to a center position in the second direction, having the first opening 23A which the first sheet support part 21A passes through, and supported by the first sheet support part 21A; the microlens sheet (second sheet member) 28 having a surface parallel to the surface of the reflective polarizing sheet 27, stacked on the reflective polarizing sheet 27, and having a coefficient of linear expansion different from a coefficient of linear expansion of the reflective polarizing sheet 27; the second sheet support part 21B which supports the one end side of the microlens sheet 28; and the second supported part 22B provided on the one end side of the microlens sheet 28 and close to the end with respect to the center position in the second direction and supported by the second sheet support part 21B, the second supported part 22B disposed at a position not superposed on at least the first opening 23A.

With this, the reflective polarizing sheet 27 is supported in the first direction, with the first supported part 22A provided on the one end side in the first direction and close to the end with respect to the center position in the second direction being supported by the first sheet support part 21A which passes through the first opening 23A. The microlens sheet 28 stacked on the reflective polarizing sheet 27 is supported in the first direction, with the second supported part 22B provided on the one end side in the first direction and close to the end with respect to the center position in the second direction being supported by the second sheet support part 21B. The reflective polarizing sheet 27 and the microlens sheet 28 thermally expand in the first direction and the second direction as the temperature environment becomes at high temperatures. In the following, operation regarding the second direction is described in detail. When the reflective polarizing sheet 27 and the microlens sheet 28 thermally expand in the second direction, each of the supported parts 22A and 22B is relatively displaced in the second direction accordingly with respect to the reflective polarizing sheet 27 and the microlens sheet 28. As described above, since the reflective polarizing sheet 27 and the microlens sheet 28 have different coefficients of thermal expansion, the displacement amount of the first supported parts 22A and that of the second supported parts 22B in the second direction with thermal expansion are different from each other.

At least the first supported part 22A has the first opening 23A, and there is a possibility that a protrusion such as a burr is formed on its opening edge due to a reason in manufacture. If this protrusion is caught on any second supported part 22B, the first supported part 22A and the second supported part 22B may stick to each other, and relative displacement may be inhibited. By contrast, since the second supported part 22B is disposed at a position not superposed on at least the first opening 23A, even if a protrusion such as a burr is formed on the opening edge of any first opening 23A, the situation hardly occurs in which that protrusion is caught on the second supported part 22B. With this, the first supported part 22A and the second supported part 22B hardly stick to each other. Therefore, even if the displacement amount of the first supported parts 22A in the second direction with thermal expansion is different from that of the second supported parts 22B, relative displacement of the first supported parts 22A and the second supported parts 22B is allowed. Thus, deformation such as a wrinkle hardly occurs in the reflective polarizing sheet 27 and the microlens sheet 28.

The second supported part 22B has the second opening 23B which the second sheet support part 21B passes through. With this, the microlens sheet 28 is supported in the first direction, with the second supported part 22B being supported by the second sheet support part 21B which passes through the second opening 23B. There is a possibility that, in addition to the first opening 23A of the first supported part 22A, the second opening 23B of the second supported part 22B may have a protrusion such as burr formed due to a reason in manufacture. However, the second opening 23B is formed in the second supported part 22B so as not to be superposed on the first opening 23A, and both of the openings 23A and 23B are arranged so as not to be superposed each other. Therefore, when the protrusion is formed on the opening edge of any first opening 23A, the situation hardly occurs in which that protrusion is caught on the opening edge of the second opening 23B. Conversely, when the protrusion is formed on the opening edge of the second opening 23B, the situation hardly occurs in which that protrusion is caught on the opening edge of the first opening 23A. With this, the first supported part 22A and the second supported part 22B hardly stick to each other, and the reflective polarizing sheet 27 and the microlens sheet 28 are made further less deformable.

The second supported part 22B has the second opening 23B disposed at a position not superposed on the first supported part 22A. With this, when a protrusion such as a burr occurs on the opening edge of any second opening 23B, the situation hardly occurs in which that protrusion is caught on the first supported part 22A. With this, the first supported part 22A and the second supported part 22B are prevented from sticking to each other, and the reflective polarizing sheet 27 and the microlens sheet 28 are made still further less deformable.

The second supported part 22B is disposed at a position not superposed on the first supported part 22A. With this, even if a protrusion such as a burr is formed on the outer edge of each supported part 22A, 22B due to a reason in manufacture, the situation hardly occurs in which that protrusion is caught on the outer edge of each supported part 22A, 22B or the opening edge of the first opening 23A. With this, the first supported part 22A and the second supported part 22B are prevented from sticking to each other, and the reflective polarizing sheet 27 and the microlens sheet 28 are made further less deformable.

The device also includes: the center-side sheet support part 24 which supports a center side in the second direction on the one end side of the reflective polarizing sheet 27 and the microlens sheet 28; the first center-side supported part 25A provided on the one end side of the reflective polarizing sheet 27 and at a center position in the second direction, having the first center-side opening 26A which the center-side sheet support part 24 passes through, and supported by the center-side sheet support part 24; and the second center-side supported part 25B provided on the one end side of the microlens sheet 28 and at the center position in the second direction, superposed on the first center-side opening 26A, having the second center-side opening 26B which the center-side sheet support part 24 passes through, and supported by the center-side sheet support part 24. With this, the first center-side supported part 25A and the second center-side supported part 25B are provided with the first center-side opening 26A and the second center-side opening 26B superposed each other and, with the common center-side sheet support part 24 passing through these first center-side opening 26A and second center-side opening 26B, the reflective polarizing sheet 27 and the microlens sheet 28 are supported on the center side in the second direction. With this, by sharing the center-side sheet support parts 24 in common, the structure is simplified. The first center-side supported part 25A and the second center-side supported part 25B are portions serving as origins when the reflective polarizing sheet 27 and the microlens sheet 28 extend along the second direction at the time of thermal expansion, and therefore hardly make relative displacement with thermal expansion in the second direction with respect to the center-side sheet support part 24, and are thus prevented from causing deformation such as a wrinkle in the reflective polarizing sheet 27 and the microlens sheet 28.

Either one of the reflective polarizing sheet 27 and the microlens sheet 28 serves as a thick sheet member which is relatively thick, and the other serves as a thin sheet member which is relatively thin, and the microlens sheet 28 as a thin sheet member is disposed so as to be stacked on a side of the reflective polarizing sheet 27 as a thick sheet member opposite to the output light side. With this, since the microlens sheet 28 as a thin sheet member is relatively thin compared with the reflective polarizing sheet 27 as a thick sheet member, deformation such as a wrinkle intrinsically tends to occur. Therefore, as described above, with the microlens sheet 28 as a thin sheet member being disposed so as to be stacked on a side of the reflective polarizing sheet 27 as a thick sheet member opposite to the output light side, even in the event that deformation such as a wrinkle occurs in the microlens sheet 28 as a thin sheet member, that deformation is less visually recognized from the user of the backlight device 12.

The reflective polarizing sheet 27 and the microlens sheet 28 serve as a first optical sheet and a second optical sheet, respectively, each of which provides optical action to light, the device includes the frame (framed-shaped member) 16 which forms a frame shape so as to extend along an outer edge of the first optical sheet and the second optical sheet and also delimits the effective output light area EA of the first optical sheet and the second optical sheet, and the first sheet support part 21A and the second sheet support part 21B are provided to the frame 16. With this, the reflective polarizing sheet 27 and the microlens sheet 28 as the first optical sheet and the second optical sheet in which the effective output light area EA is delimited by the frame 16 are supported in the first direction by the first sheet support part 21A and the second sheet support part 21B provided to the frame 16. Therefore, the arrangement of the effective output light area EA in the reflective polarizing sheet 27 and the microlens sheet 28 as the first optical sheet and the second optical sheet becomes appropriate. Since deformation such as a wrinkle hardly occurs in the reflective polarizing sheet 27 and the microlens sheet 28 as the first optical sheet and the second optical sheet, the output light amount from the effective output light area E is made less nonuniform, and the luminance distribution of emitted light is made uniform.

The liquid crystal display device (display device) 10 according to the present embodiment includes the above-described backlight device 12 and the liquid crystal panel 11 which displays an image by using light applied from the backlight device 12. According to the liquid crystal display device 10 structured as described above, the reflective polarizing sheet 27 and the microlens sheet 28 included in the backlight device 12 are made less deformable, and therefore display performance is excellent.

### Second Embodiment

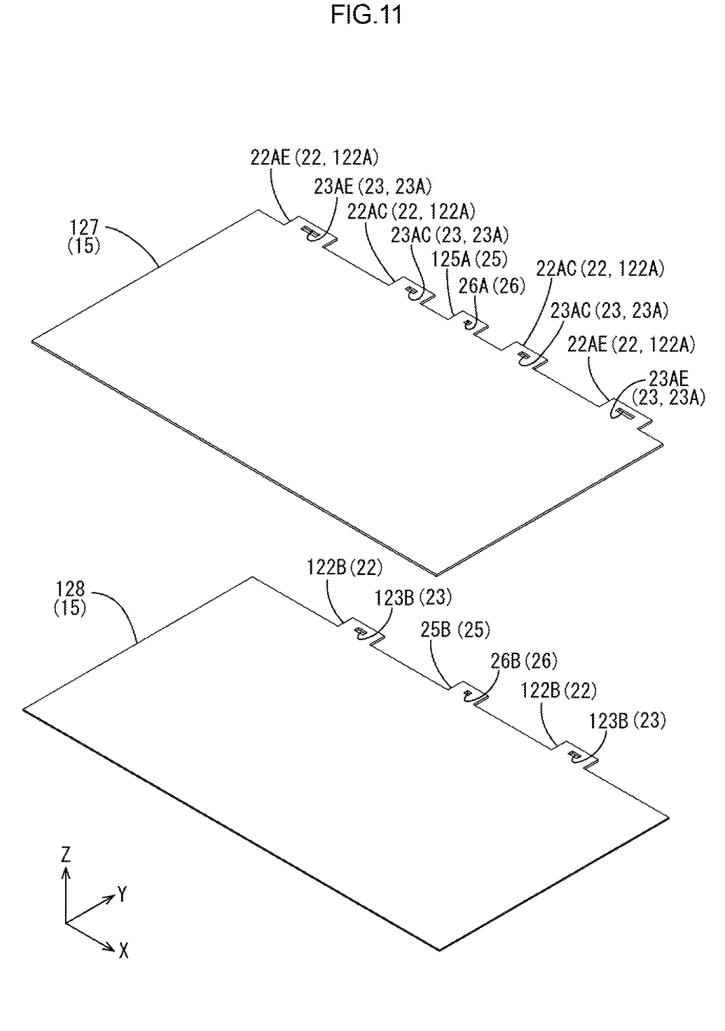

A second embodiment of the present invention is described with FIG. 11 to FIG. 13. In this second embodiment, one with a modified first sheet support structure is depicted. Redundant description about the structure, operation, and effect similar to those of the above-described first embodiment is omitted.

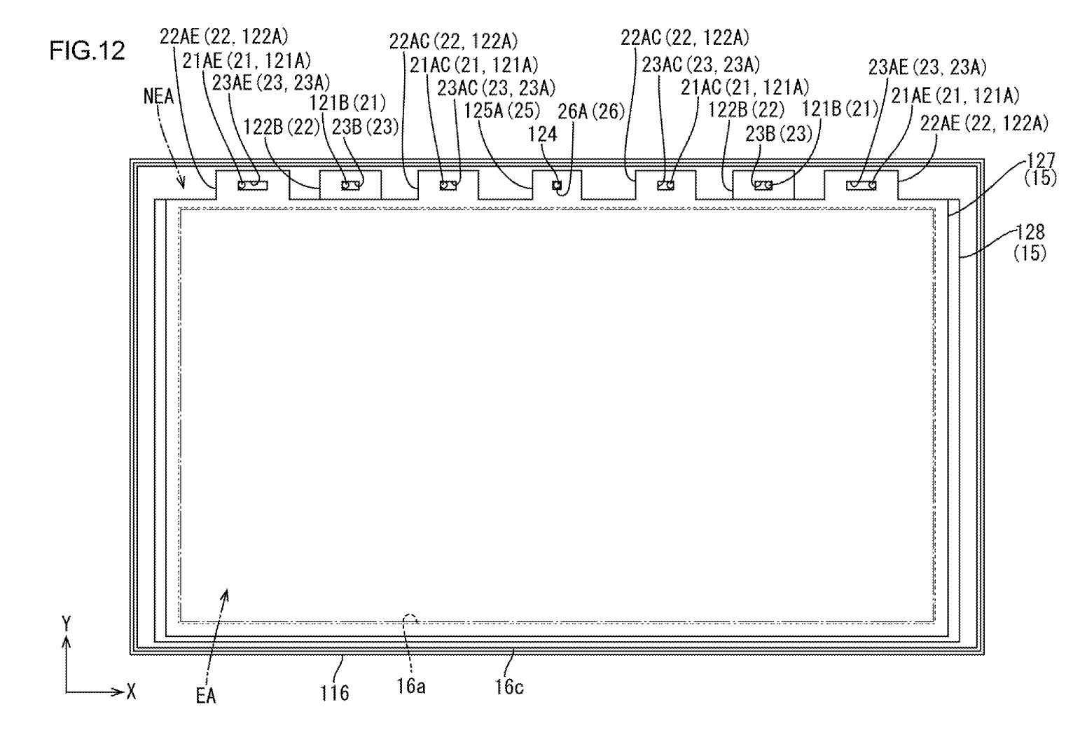

In the first sheet support structure according to the present embodiment, two sets are provided at positions each at a different distance from the center position of a reflecting polarizing sheet 127 in the horizontal direction, as depicted in FIG. 11 and FIG. 12. The first sheet support structure includes a center-side first sheet support structure positioned close to the center of the reflective polarizing sheet 127 in the horizontal direction and an end-side first sheet support structure positioned close to an end of the reflective polarizing sheet 127 in the horizontal direction. The center-side first sheet support structure is formed of paired center-side first sheet support parts 21AC and paired center-side first supported parts 22AC each having a center-side first opening 23AC which the center-side first sheet support part 21AC passes through and supported by the center-side first sheet support part 21AC. The end-side first sheet support structure is formed of paired end-side first sheet support parts 21AE and paired end-side first supported parts 22AE each having an end-side first opening 23AE which the end-side first sheet support part 21AE passes through and supported by the end-side first sheet support part 21AE.

The center-side first sheet support parts 21AC are each disposed at a position interposed between the center-side sheet support part 124 and the second sheet support part 121B of the frame 116 in the horizontal direction, as depicted in FIG. 12. In a state in which the reflective polarizing sheet 127 and a microlens sheet 128 are laminated and arranged, the center-side first supported part 22AC is disposed at a position interposed between a first center-side supported part 125A and a second supported part 122B in the horizontal direction. The center-side first supported parts 22AC are each arranged as disposed in the horizontal direction so as not to be superposed on both of the first center-side supported part 125A and the second supported parts 122B in a planar view. By contrast, the end-side first sheet support parts 21AE are disposed at positions opposite to the center-side first sheet support part 21AC side, that is, at positions most close to the end, with respect to the second sheet support parts 121B in the horizontal direction in the frame 116. The end-side first supported parts 22AE are disposed at positions opposite to the center-side first supported part 22AC side, that is, at positions most close to the end, with respect to the second supported parts 122B in the horizontal direction. The end-side first supported parts 22AE are arranged as displaced in the horizontal direction so as not to be superposed on the second supported part 122B in a planar view.

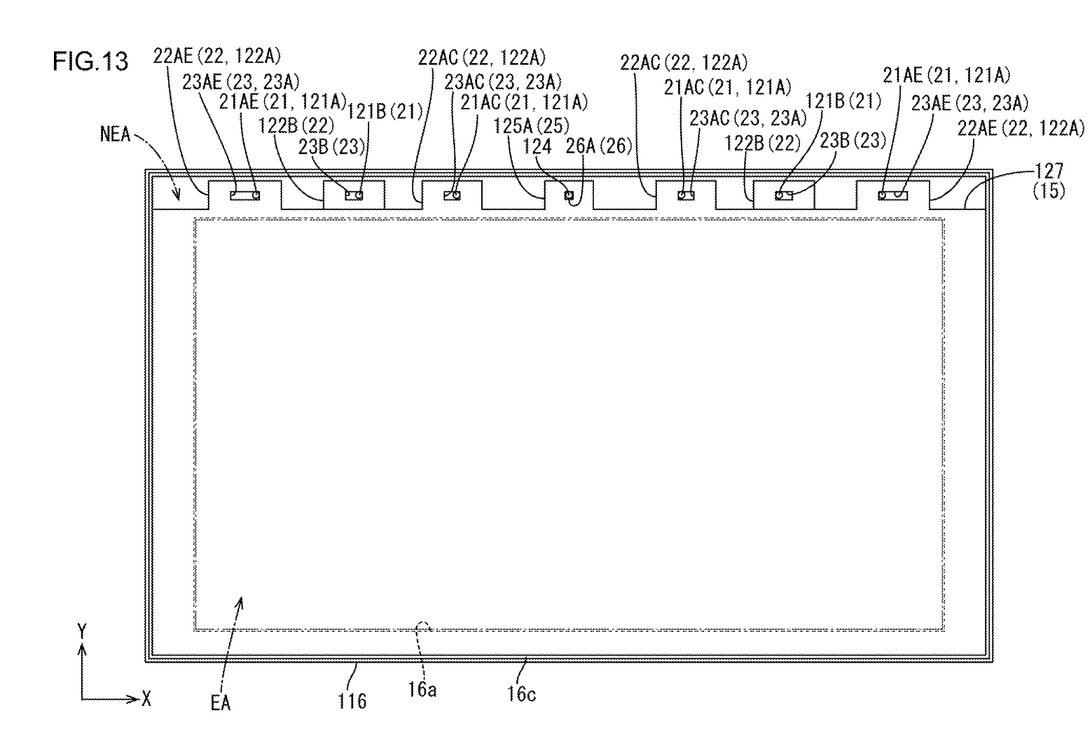

As depicted in FIG. 12 and FIG. 13, compared with the end-side first supported parts 22AE, the center-side first supported parts 22AC have a relatively small displacement amount in the horizontal direction with thermal expansion of the reflective polarizing sheet 127. Therefore, the center-side first openings 23AC provided in the center-side first supported parts 22AC have a relatively small length dimension compared with the end-side first opening 23AE. By contrast, compared with the center-side first supported parts 22AC, the end-side first supported parts 22AE have a relatively large displacement amount in the horizontal direction with thermal expansion of the reflective polarizing sheet 127. Therefore, the end-side first openings 23AE provided to the end-side first supported parts 22AE have a relatively large length dimension, compared with the center-side first openings 23AC.

In this manner, the reflective polarizing sheet 127 is supported in the vertical direction by two sets of the first sheet support structure at four locations in total, and therefore is a “heavy sheet member” which is relatively heavy compared with the microlens sheet 128, but loads acting on each of the supported parts 22AC, 22AE, and 125A with supporting are appropriately distributed. With this, the situation hardly occurs in which each of the supported parts 22AC, 22AE, and 125A is damaged or the like by the weight of the reflective polarizing sheet 127, and stable support can be achieved.

As described above, according to the present embodiment, either one of the reflective polarizing sheet 127 and the microlens sheet 128 serves as a heavy sheet member which is relatively heavy, and the other serves as a light-weight sheet member which has a relatively light weight. The reflective polarizing sheet 127 as a heavy sheet member has a larger number of installations of the first supported parts 122A than the microlens sheet 128 as a light-weight sheet member. The reflective polarizing sheet 127 as a heavy sheet member is relatively heavy compared with the microlens sheet 128 as a light-weight sheet member, and therefore the loads on the first supported parts 122A as a support location by the first sheet support parts 121A is large. In this regard, the reflective polarizing sheet 127 as a heavy sheet member has the larger number of installations of the first supported parts 122A than the microlens sheet 128 as a light-weight sheet member. Therefore, the loads on the first supported parts 122A are distributed. With this, the situation hardly occurs in which any first supported part 122A is damaged or the like by the weight of the reflective polarizing sheet 127 as a heavy sheet member, and stable support can be achieved.

### Third Embodiment

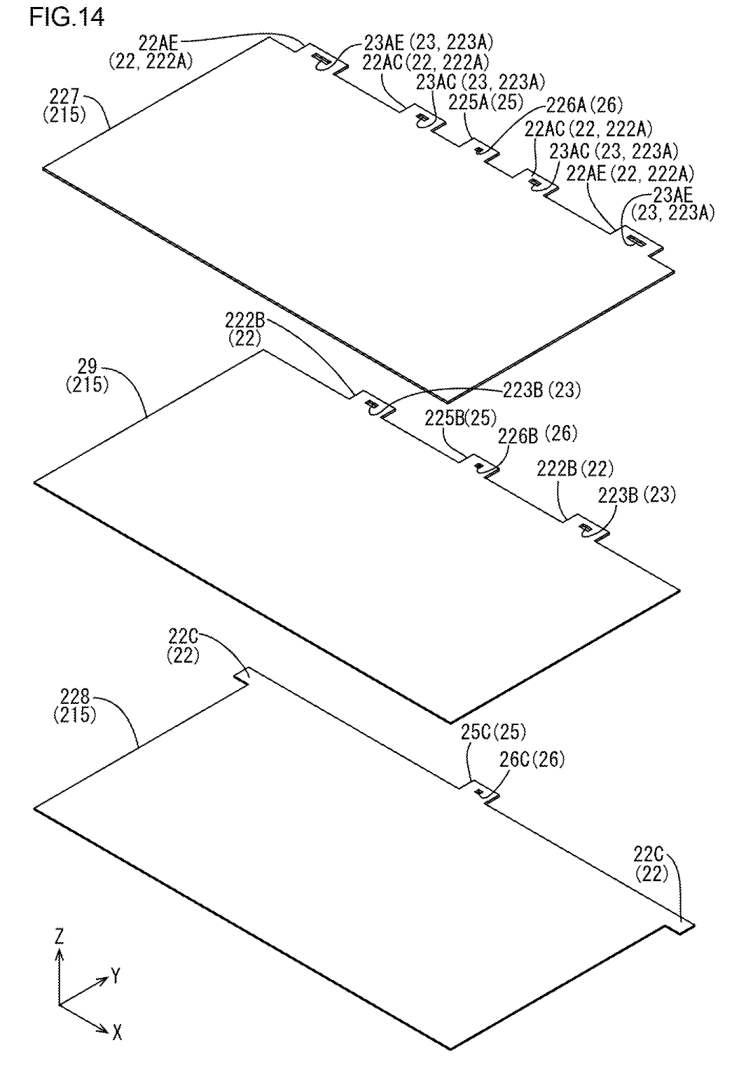

A third embodiment of the present invention is described with FIG. 14 to FIG. 20. In this third embodiment, one with the number of optical sheets 215 and so forth changed from the above-described second embodiment is depicted. Redundant description about the structure, operation, and effect similar to those of the above-described second embodiment is omitted.

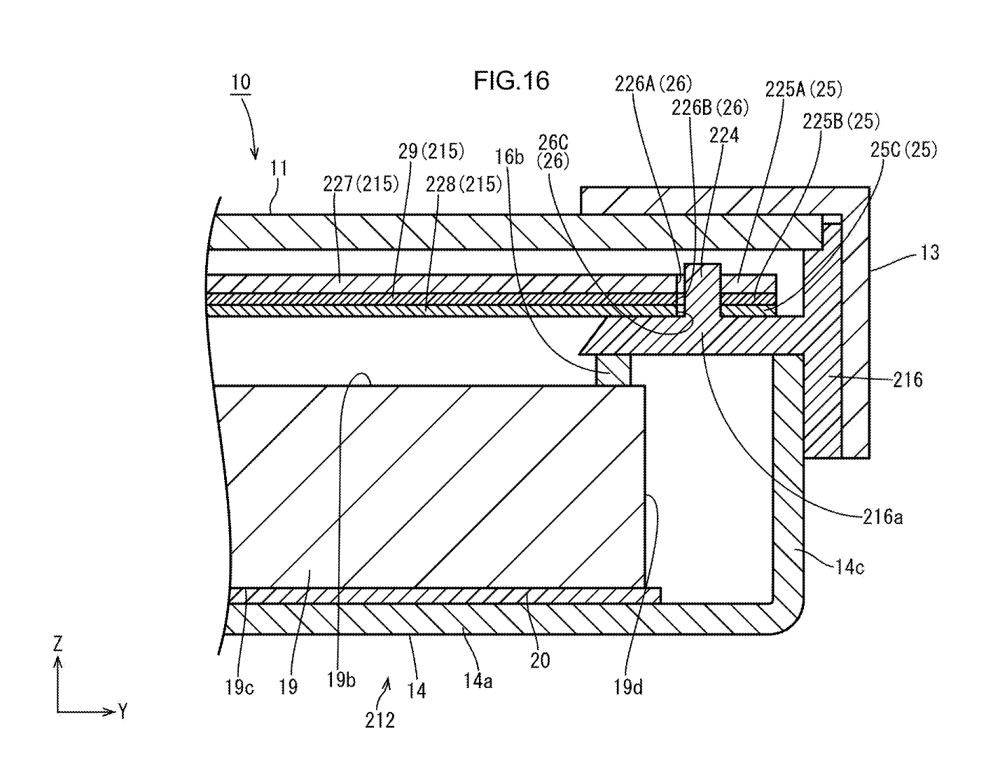

An optical sheet 215 according to the present embodiment includes, as depicted in FIG. 14 and FIG. 16, in addition to a reflective polarizing sheet 227 and a microlens sheet (third sheet member, third optical sheet) 228, a prism sheet (second sheet member, second optical sheet) 29 which provides anisotropic light gathering action to light, that is, is configured of three sheets in total. The prism sheet 29 has a surface parallel to each surface of the reflective polarizing sheet 227 and the microlens sheet 228, and is disposed so as to be stacked on a back side (opposite to an output light side) of the reflective polarizing sheet 227 and be stacked on a front side (output light side) of the microlens sheet 228, that is, be interposed between the reflective polarizing sheet 227 and the microlens sheet 228. Therefore, the microlens sheet 228 is disposed so as to be stacked on the back side of the prism sheet 29, that is, be stacked on a side opposite to a reflective polarizing sheet 227 side. In this manner, the optical sheet 215 is formed with the reflective polarizing sheet 227, the prism sheet 29, and the microlens sheet 228 laminated in this order from the front side.

The prism sheet 29 has, although detailed description is omitted, a base material and a prism part provided on a front plate surface of the base material. Of these, the prism part is configured of unit prisms extending along the X axis direction, with many aligned and disposed along the Y axis direction. The unit prisms form a rail shape (linear shape) parallel to the X axis direction in a planar view, and its cross-section shape along the Y axis direction is a substantially isosceles triangle shape. With the structure as described above, the prism sheet 29 selectively provides light with light gathering action (anisotropic light gathering action) in the Y axis direction (direction of alignment of the unit prisms, direction orthogonal to the extending direction of the unit prisms). The base material of the prism sheet 29 is made of synthetic resin, for example, PET, that is, the same material as that of the microlens sheet 228, and its coefficient of linear expansion is approximately 2 to 3×10⁻⁵/° C., which is substantially equal to that of the microlens sheet 228 and is smaller than that of the reflective polarizing sheet 227. As for the base material, its thickness is assumed to be on the order of a range from 100 μm to 300 μm, preferably on the order of 200 μm. As for the prism part, its thickness is assumed to be on the order of a range from 30 μm to 40 μm. Therefore, the base material is dominant in weight and thickness in the prism sheet 29, and also dominant in mechanical properties and thermal properties. The prism sheet 29 has an entire thickness on the order of a range from 130 μm to 340 μm, preferably on the order of 250 μm, which is substantially equal to that of the microlens sheet 228 and thinner than that of the reflective polarizing sheet 227. In this manner, the prism sheet 29 has a relatively small coefficient of linear expansion compared with the reflective polarizing sheet 227, and can therefore be said as a “small-coefficient-of-linear-expansion optical sheet (small-coefficient-of-linear-expansion sheet member)”. The prism sheet 29 is formed so that its short-side dimension (dimension in the first direction) and long-side dimension (dimension in the second direction) are substantially equal to each dimension of the microlens sheet 228 and larger than each dimension of the reflective polarizing sheet 27. Compared with the reflective polarizing sheet 227, the prism sheet 29 has a relatively light weight and is relatively thin, and can be therefore said as a “light-weight optical sheet (light-weight sheet member)” and a “thin optical sheet (thin sheet member)” of a thin type. Therefore, the backlight device 212 according to the present embodiment includes two “small-coefficient-of-linear-expansion optical sheets”, “light-weight optical sheets”, or “thin sheet members”. Since this prism sheet 29 is a “thin sheet member”, compared with the reflective polarizing sheet 227 as a “thick sheet member”, deformation such as a warp or wrinkle intrinsically tends to occur. However, the prism sheet 29 is disposed so as to be stacked on the back side, that is, a side of the reflective polarizing sheet 227 opposite to the output light side. Therefore, even in the event that deformation such as a warp or wrinkle occurs in the prism sheet 29, that deformation is less visually recognized from a user of the backlight device 212.

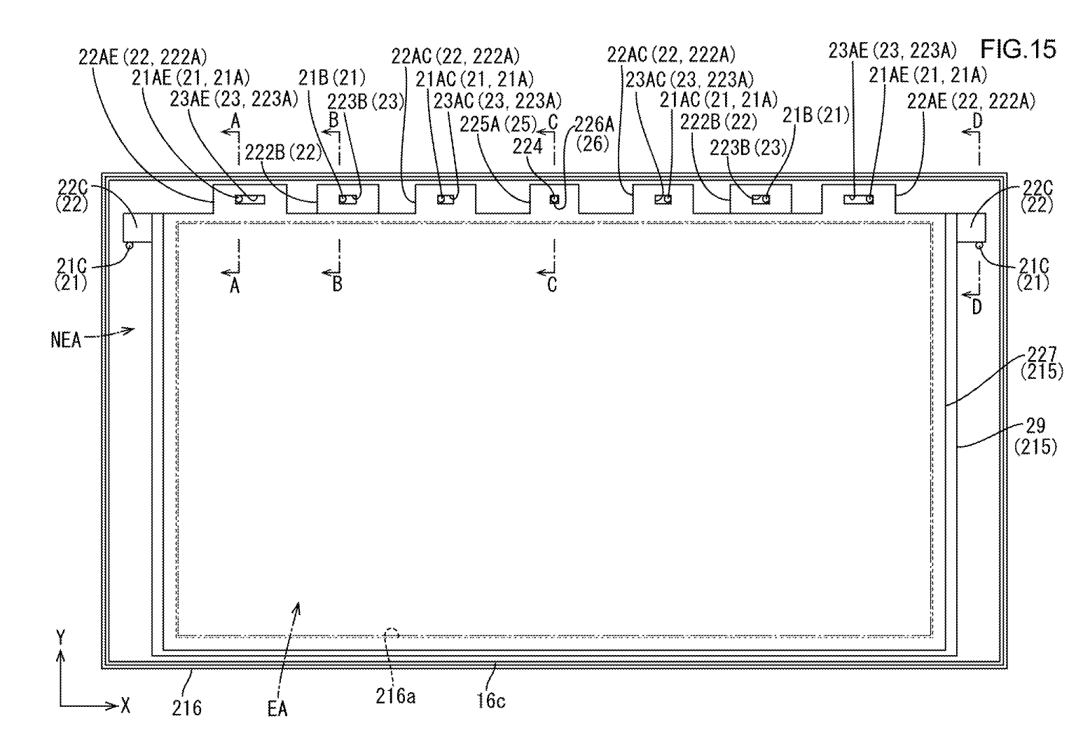

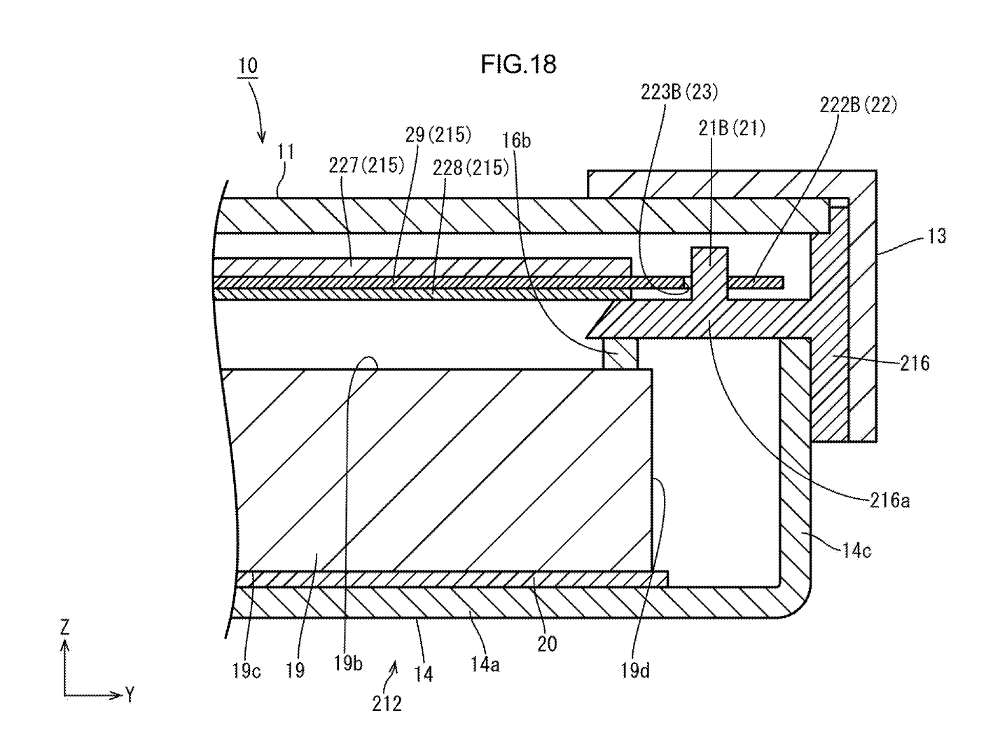

The prism sheet 29 structured as described above is supported by the second sheet support structure described in the above-described first embodiment with respect to the vertical direction. Therefore, as depicted in FIG. 15 and FIG. 18, the prism sheet 29 has second supported parts 222B and second openings 223B identical to those the microlens sheet 28 has in the above-described first embodiment (refer to FIG. 5 and FIG. 9) and, by the second sheet support part 221B passing through the second opening 223B, the upper end side, which is also an end side with respect to the horizontal direction, is supported with respect to the vertical direction. As depicted in FIG. 15 and FIG. 16, the prism sheet 29 has a second center-side supported part 225B and a second center-side opening 226B identical to those the microlens sheet 28 has in the above-described first embodiment (refer to FIG. 4 and FIG. 5), and is supported in the vertical direction by a center-side sheet support part 224 passing through the second center-side opening 226B on the upper end side and the center side in the horizontal direction. These structures are as described in the above-described first embodiment, and detailed description is omitted.

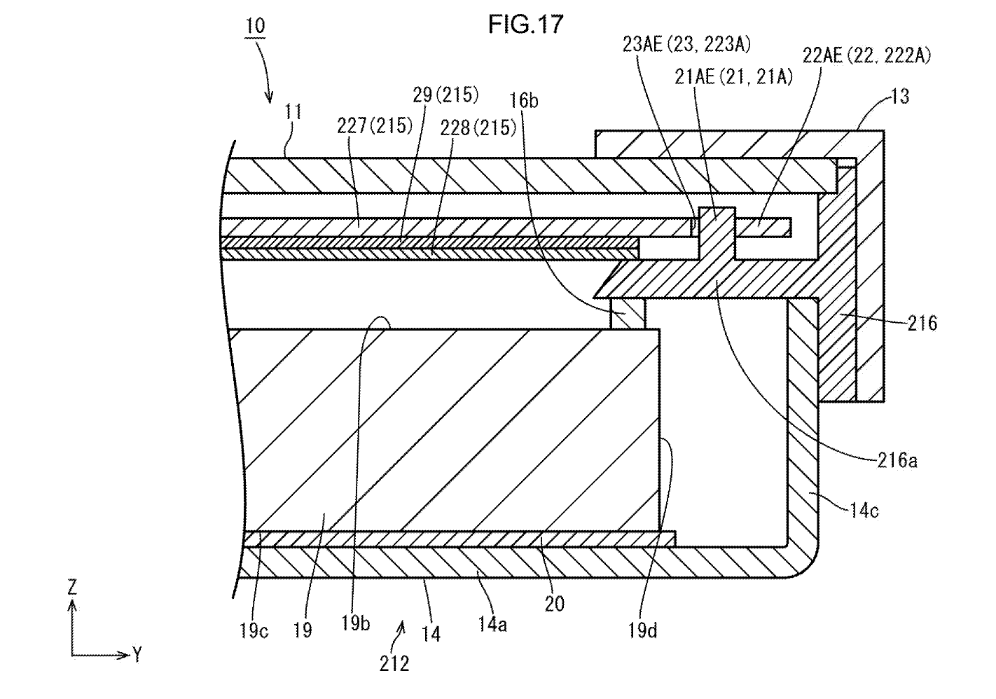

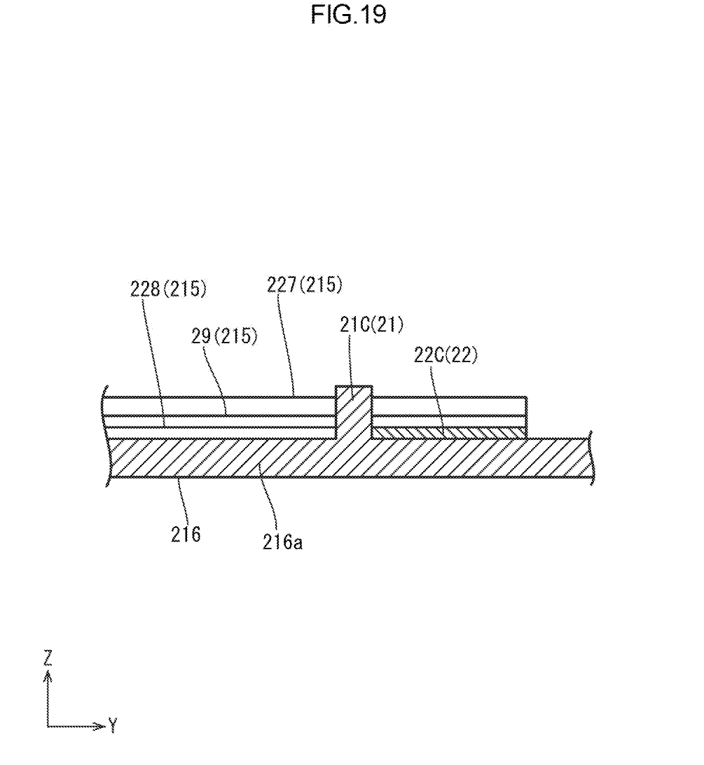

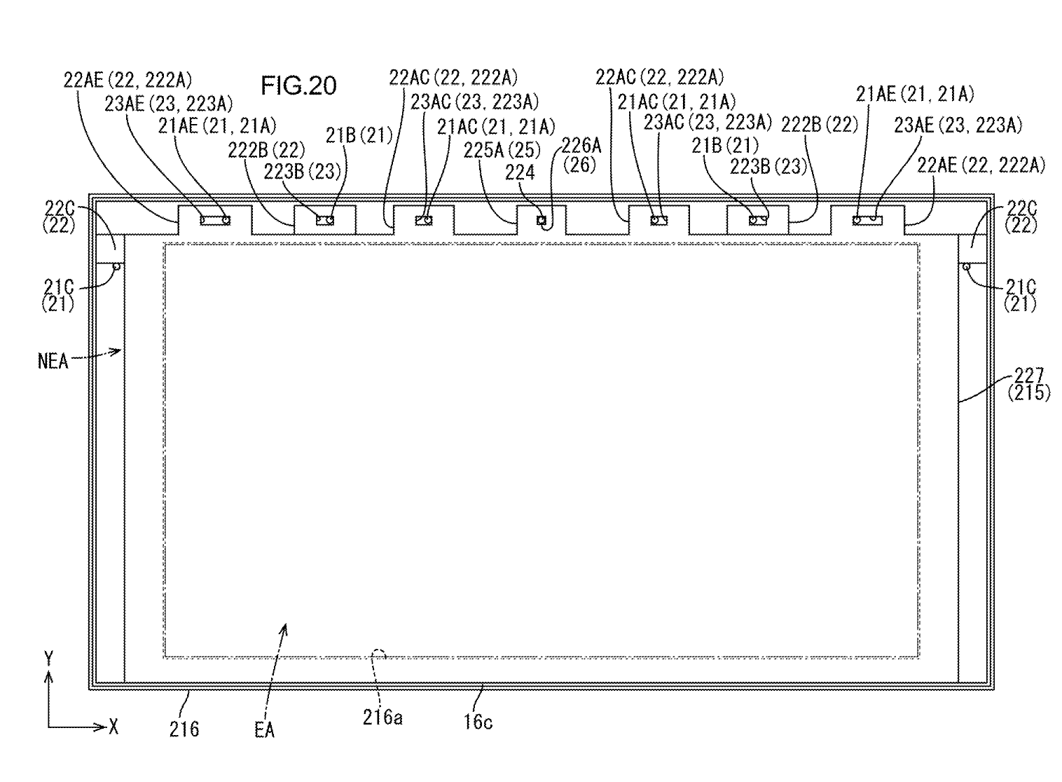

The microlens sheet 228 disposed so as to be stacked on the side opposite to the reflective polarizing sheet 227 side with respect to the prism sheet 29 is supported by a third sheet support structure, which will be described next, in the vertical direction. The third sheet support structure includes paired third sheet support parts 21C which support an upper end side of the microlens sheet 228 in the vertical direction and paired third supported parts 22C provided to an upper end of the microlens sheet 228 in the vertical direction and supported by the third sheet support parts 21C, as depicted in FIG. 15. The paired third sheet support parts 21C are provided to both short side of the frame-shaped part 216a of the frame 216 in the horizontal direction, and each form a columnar shape protruding from the frame-shaped part 216a toward the front side. The paired third supported parts 22C are provided so as to protrude along the horizontal direction from both side edges (outer edges) of the microlens sheet 228 extending along the vertical direction. That is, the third supported parts 22C are disposed at end positions in the horizontal direction on the upper end side of the microlens sheet 228, and each positioned closer to an end in the horizontal direction than first supported parts 222A and the second supported parts 222B and arranged so as not to be superposed on the first supported parts 222A and second supported parts 222B in a planar view. The third supported parts 22C each form a substantially laterally-elongated square shape in a planar view, and are each formed of a non-opening protrusion piece without having an opening structure as the first supported parts 222A and the second supported parts 222B depicted in FIG. 16 and FIG. 17. The third supported part 22C is disposed, as depicted in FIG. 15 and FIG. 19, so that its lower edge in the vertical direction is adjacent to an upper side of the third sheet support part 21C in the vertical direction, and serves as a portion of contact with the third sheet support part 21C. The lower edge (portion of contact) of the third supported part 22C linearly extends along the horizontal direction and parallel to the length direction of first openings 223A and the second opening 223B. This can guide displacement operation of the third supported parts 22C being displaced along the horizontal direction as the microlens sheet 228 thermally expands, as depicted in FIG. 15 and FIG. 20.

According to this structure, the microlens sheet 228 stacked on the side opposite to the reflective polarizing sheet 227 side with respect to the prism sheet 29 is supported in the vertical direction, with the third supported parts 22C each provided on one end side in the extending direction and close to an end with respect to the center position in the horizontal direction being supported by the third sheet support part 21C. The third supported parts 22C are disposed at positions not superposed on the first supported parts 222A and the second supported parts 222B. Therefore, even if a protrusion such as a burr is formed on the outer edge of any of the supported parts 22C, 222A, and 222B or the opening edge of any of the openings 223A and 223B due to a reason in manufacture, the situation hardly occurs in which that protrusion is caught on the outer edge of any of the supported parts 22C, 222A, and 222B or the opening edge of any of the openings 223A and 223B. With this, the third supported parts 22C is prevented from sticking to the first supported parts 222A and the second supported parts 222B, and each of the sheets 29, 227, and 228 is made less deformable. Furthermore, the third supported parts included in the microlens sheet 228 as a “small-coefficient-of-linear-expansion sheet member” each form a protrusion piece shape protruding from the outer edge of the microlens sheet 228 along the horizontal direction, and are each supported by the third sheet support part 21C even with non-opening. As being made with non-opening, the size of the third supported part 22C in the horizontal direction is decreased. Since the microlens sheet 228 has a coefficient of linear expansion smaller than that of the reflective polarizing sheet 227, the displacement amount in the horizontal direction with thermal expansion regarding the third supported part 22C is relatively small, compared with the displacement amount regarding the first supported parts 222A. This is suitable for making the backlight device 212 as a narrow picture frame.

In the microlens sheet 228, a portion on an upper end side and a center side in the horizontal direction is supported in the vertical direction by the center-side sheet support part 224, as depicted in FIG. 14 and FIG. 16. The microlens sheet 228 is provided with a third center-side supported part 25C on the upper end in the vertical direction and at the center position in the horizontal direction. In this third center-side supported part 25C, a third center-side opening 26C is formed, which the center-side sheet support part 224 passes through. The third center-side supported part 25C is disposed so as to be superposed on a first center-side opening 225A and the second center-side opening 225B in a planar view. Similarly, the third center-side opening 26C is disposed so as to be superposed on the first center-side opening 226A and the second center-side opening 226B in a planar view. Therefore, as for the microlens sheet 228, the upper end side and the center side in the horizontal direction of the reflective polarizing sheet 227 and the microlens sheet 228 are collectively supported in the vertical direction by the center-side sheet support part 224.

As described above, according to the present embodiment, the device includes: the microlens sheet (third sheet member) 228 having a surface parallel to the surface of the reflective polarizing sheet 227, stacked on a side of the prism sheet (second sheet member) 29 opposite to the reflective polarizing sheet 227 side, and having a coefficient of linear expansion different from at least the coefficient of linear expansion of the reflective polarizing sheet 227; the third sheet support part 21C which supports the one end side of the microlens sheet 228; the third supported part 22C provided on the one end side of the microlens sheet 228 and close to an end with respect to a center position in the second direction and supported by the third sheet support part 21C, the third supported part 22C disposed at a position not superposed on the first supported part 222A and the second supported part 222B. With this, the microlens sheet 228 stacked on the side of the prism sheet 29 opposite to the reflective polarizing sheet 227 side is supported in the first direction, with the third supported parts 22C each provided on one end side in the first direction and close to an end with respect to the center position in the second direction being supported by the third sheet support part 21C. The third supported parts 22C are disposed at positions not superposed on the first supported parts 222A and the second supported parts 222B. Therefore, even if a protrusion such as a burr is formed on the outer edge of each of the supported parts 22C, 222A, and 222B or the opening edge of the first openings 223A due to a reason in manufacture, the situation hardly occurs in which that protrusion is caught on the outer edge of each of the supported parts 22C, 222A, and 222B or the opening edge of the openings 223A. With this, the third supported parts 22C is prevented from sticking to the first supported parts 222A and the second supported parts 222B, and the reflective polarizing sheet 227, the microlens sheet 228, and the prism sheet 29 are made further less deformable.

At least either one of the prism sheet 29 and the microlens sheet 228 is a small-coefficient-of-linear-expansion sheet member having a coefficient of linear expansion smaller than that of the reflective polarizing sheet 27, and at least either of the second supported parts 222B and the third supported parts 22C included in the prism sheet 29 and the microlens sheet 228 as a small-coefficient-of linear-expansion sheet member each form a non-opening protrusion piece shape protruding from the outer edge of the relevant one of the prism sheet 29 and the microlens sheet 228 as a small-coefficient-of-linear-expansion sheet member along the second direction. With this, at least either of the second supported parts 222B and the third supported parts 22C included in the relevant one of the prism sheet 29 and the microlens sheet 228 as a small-coefficient-of-linear-expansion sheet member each form a protrusion piece shape protruding from the outer edge of the relevant one of the prism sheet 29 and the microlens sheet 228 as a small-coefficient-of-linear-expansion sheet member along the second direction, and is therefore supported by at least either of the second sheet support parts 221B and the third sheet support parts 21C even in the case of non-opening. With at least either of the second supported parts 222B and the third supported parts 22C being made with non-opening, the size in the second direction is decreased. Since the prism sheet 29 and the microlens sheet 228 as a small-coefficient-of-linear-expansion sheet member has a coefficient of linear expansion smaller than that of the reflective polarizing sheet 227, the displacement amount in the second direction with thermal expansion regarding at least either of the second supported parts 222B and the third supported parts 22C is relatively small, compared with the displacement amount regarding the first supported parts 222A. This is suitable for making the backlight device 212 as a narrow picture frame.

### Fourth Embodiment

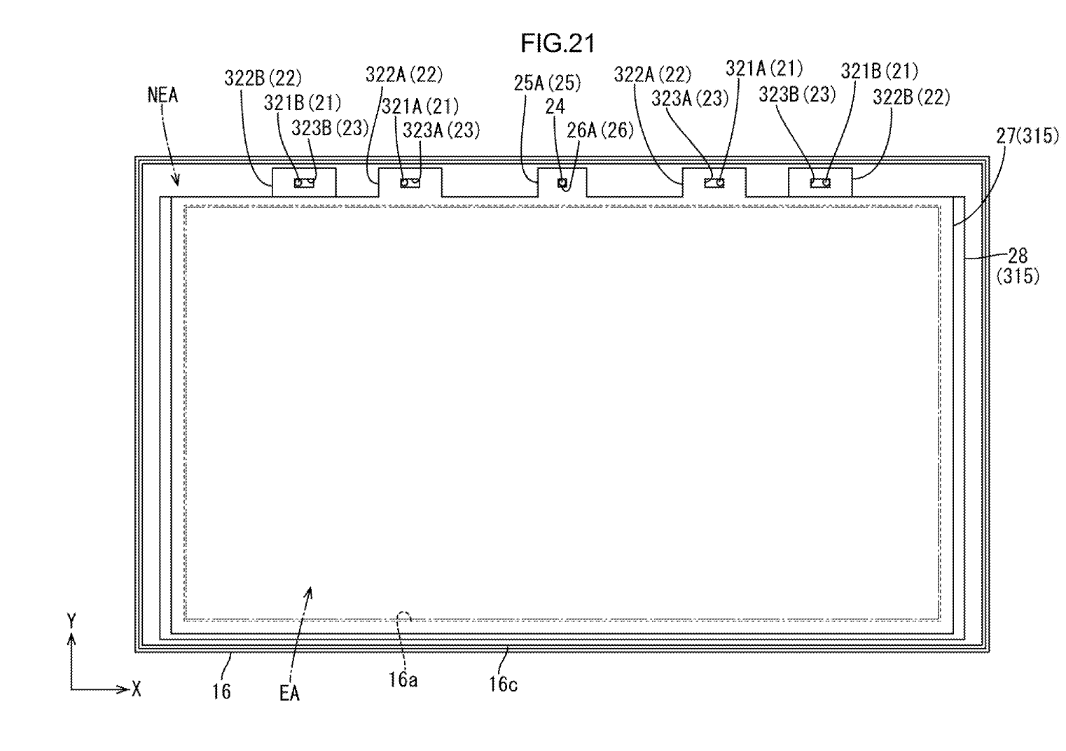

A fourth embodiment of the present invention is described with FIG. 21. In this fourth embodiment, one is described in which the arrangement of first sheet support parts 321A, second sheet support parts 321B, first supported parts 322A, and second supported parts 322B is changed from the above-described first embodiment. Redundant description about the structure, operation, and effect similar to those of the above-described first embodiment is omitted.

The first sheet support parts 321A and the first supported parts 322A according to the present embodiment are disposed close to the center in the horizontal direction of the optical sheet 315 than the second sheet support parts 321B and the second supported parts 322B, as depicted in FIG. 21. By contrast, the second sheet support parts 321B and the second supported parts 322B are disposed close to the ends in the horizontal direction of the optical sheet 315 than the first sheet support parts 321A and the first supported parts 322A. With the change of the arrangement of the first supported parts 322A and the second supported part 322B, the length dimensions of each of first openings 323A is made smaller than that described in the first embodiment, while the length dimensions of each of second openings 323B is made larger than that described in the first embodiment. With the change of the length dimensions of the first openings 323A and the second openings 323B, the long-side dimension of each of the first supported parts 322A is made smaller than that described in the first embodiment, while the long-side dimension of each of the second supported parts 322B is made larger than that described in the first embodiment.

### Fifth Embodiment

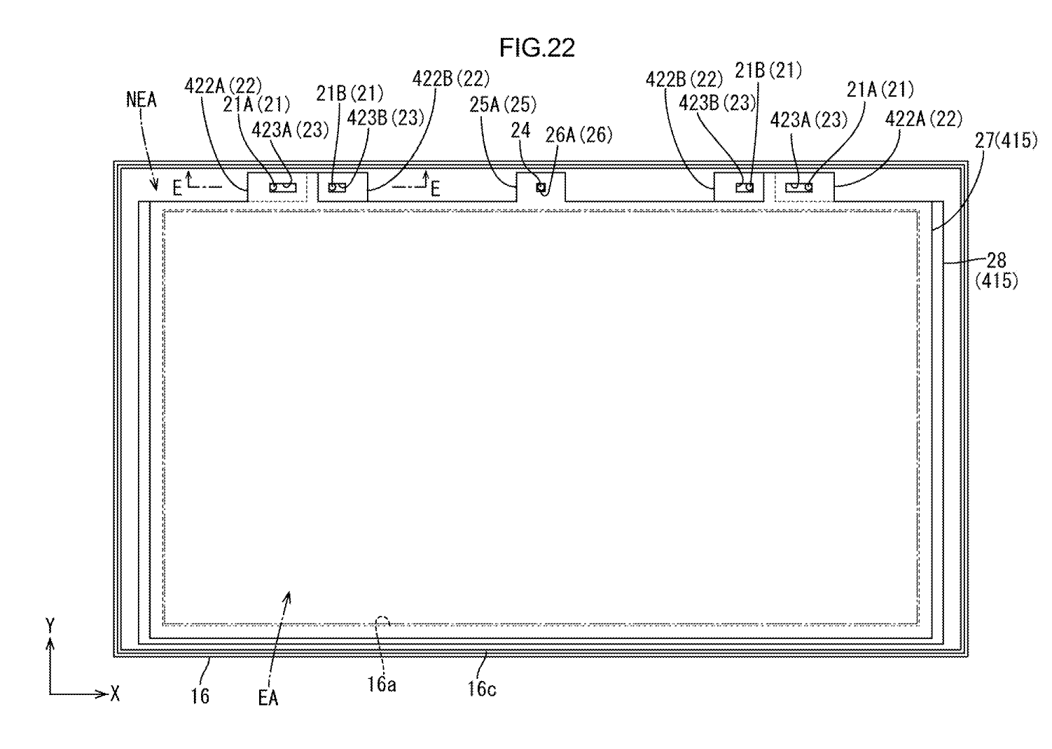

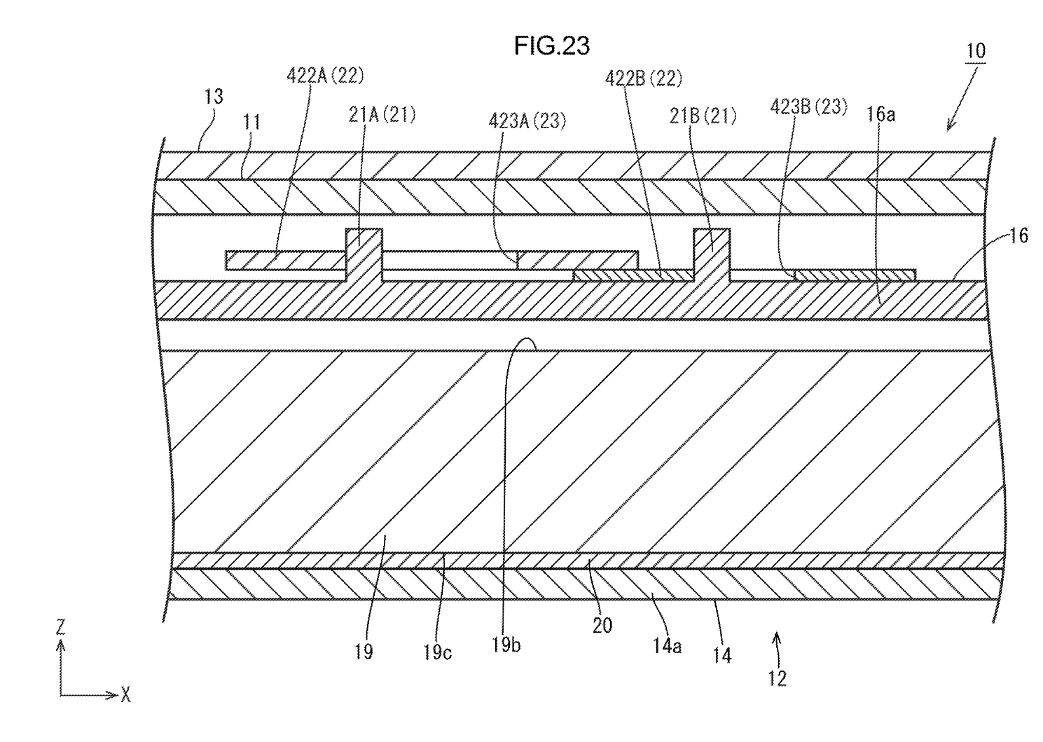

A fifth embodiment of the present invention is described with FIG. 22 or FIG. 23. In this fifth embodiment, one is described in which the arrangement of first supported parts 422A and second supported parts 422B is changed form the above-described first embodiment. Redundant description about the structure, operation, and effect similar to those of the above-described first embodiment is omitted.

The first supported parts 422A and the second supported parts 422B according to the mount board are disposed so as to be partially superposed each other in a planar view, as depicted in FIG. 22 and FIG. 23. In detail, the end of each of the first supported parts 422A on the center side of an optical sheet 415 in the horizontal direction is disposed so as to be superposed on an end of the each of the second supported parts 422B on an end side of the optical sheet 415 in the horizontal direction. On the other hand, the first supported parts 422A and the second supported parts 422B are disposed so that first openings 423A and second openings 423B are not superposed one another in a planar view, the first openings 423A and second supported parts 422B are not superposed one another and, furthermore, the second openings 423B are not superposed on the first supported parts 422A. According to this structure, even if a protrusion such as a burr is formed on the opening edge of any first opening 423A and the opening edge of any second opening 423B, the situation hardly occurs in which that protrusion is caught on the outer edge of any first supported part 422A, the outer edge of any second supported part 422B, the opening edge of any first opening 423A, and the opening edge of any second opening 423B. With this, as with the above-described first embodiment, the first supported parts 422A and the second supported parts 422B hardly stick to one another, and the optical sheet 415 is made further less deformable.

### Sixth Embodiment

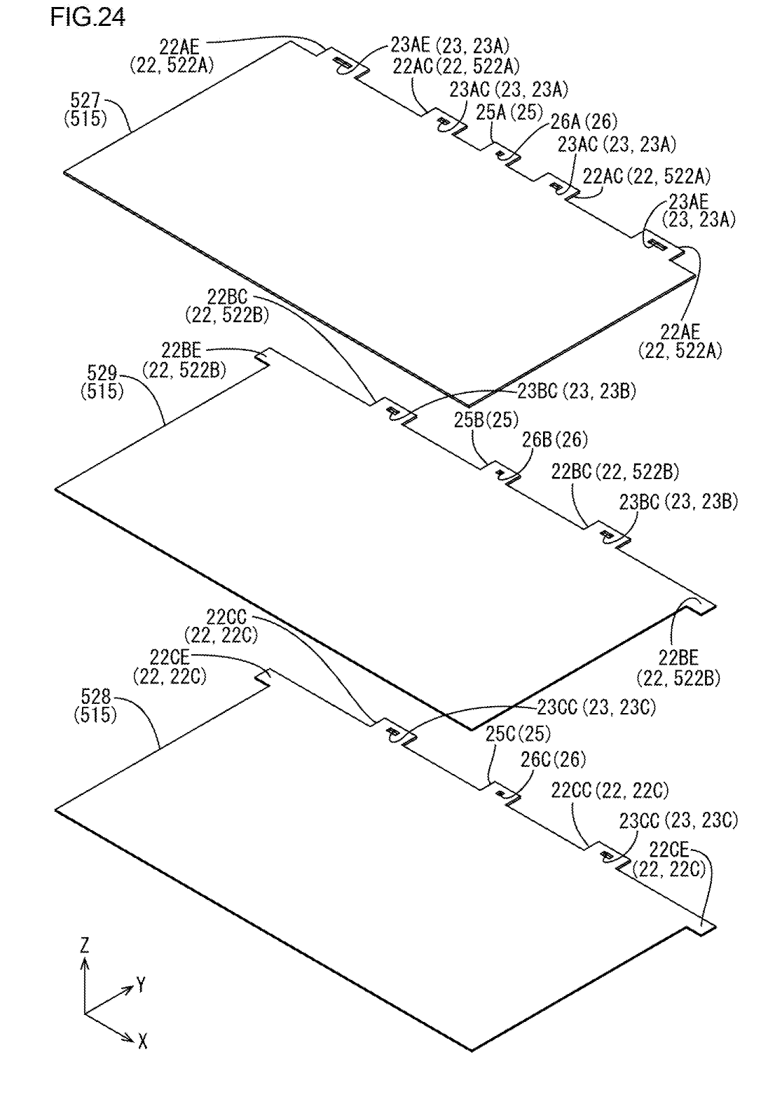

A sixth embodiment of the present invention is described with FIG. 24 to FIG. 26. In this sixth embodiment, the second sheet support structure and the third sheet support structure are changed from the above-described third embodiment. Redundant description about the structure, operation, and effect similar to those of the above-described third embodiment is omitted.

The second sheet support structure and the third sheet support structure according to the present embodiment are provided as two sets at positions each at a difference distance from the center position of a microlens sheet 528 and a prism sheet 529 in the horizontal direction as depicted in FIG. 24. The second sheet support structure and the third sheet support structure include a center-side second sheet support structure and a center-side third sheet support structure positioned close to the center of the microlens sheet 528 and the prism sheet 529 in the horizontal direction and an end-side second sheet support structure and an end-side third sheet support structure positioned close to an end of the microlens sheet 528 and the prism sheet 529 in the horizontal direction.

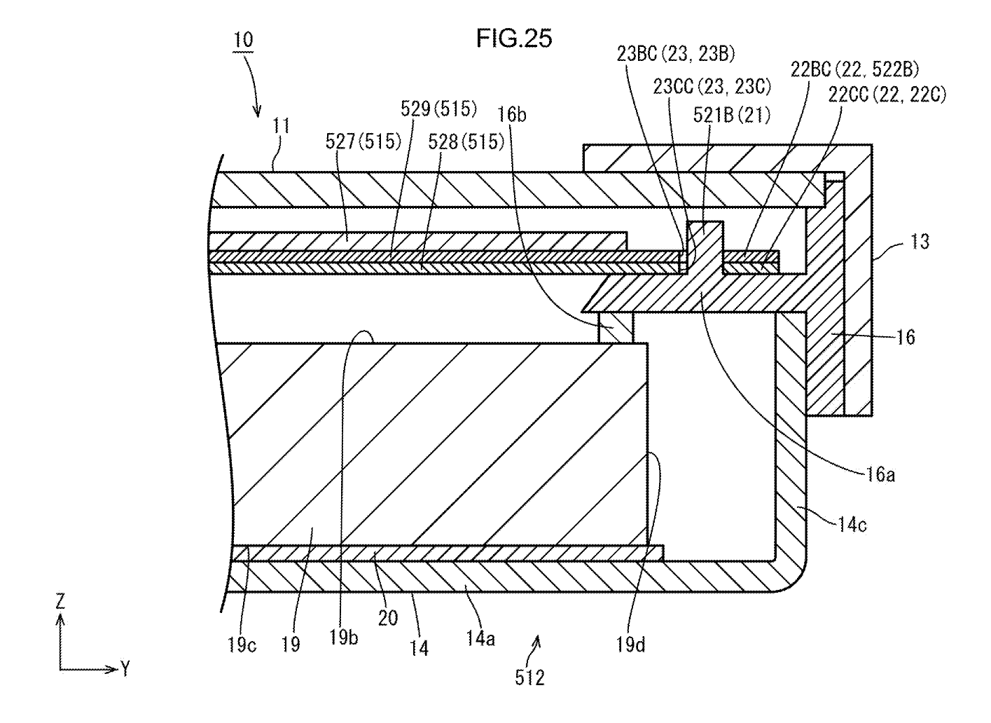

The center-side second sheet support structure has paired center-side second supported parts 22BC provided at positions each closer to an end than the center position of the upper end of the prism sheet 529 in the horizontal direction, as depicted in FIG. 24 and FIG. 25. The center-side second supported parts 22BC each have a center-side second opening 23BC which a second sheet support part 521B passes through, and supported by the second sheet support part 521B in the vertical direction. This center-side second supported parts 22BC are substantially identical to the second supported parts 22B described in the above-described first embodiment. The center-side third sheet support structure has paired center-side third supported parts 22CC provided at positions each closer to an end than the center position of the upper end of the microlens sheet 528 in the horizontal direction. The center-side third supported parts 22CC are disposed at positions superposed on the above-described center-side second supported parts 22BC in a planar view. The center-side third supported parts 22CC each have a center-side third opening 23CC superposed on the center-side second opening 23BC in a planar view and which a second sheet support part 521B passes through, and is supported by the second sheet support part 521B in the vertical direction. In this manner, the center-side second sheet support structure and the center-side third sheet support structure are configured so that the center-side second supported parts 22BB and the center-side third supported parts 22CC are collectively supported by the common second sheet support parts 521B. Since the center-side third supported part 22CC and the center-side second supported part 22BC are arranged so as to be superposed each other in a planar view, if a protrusion such as a burr is formed on the opening edge of any center-side second opening 23BC or the opening edge of any center-side third opening 23CC, the situation can occur in which the center-side third supported part 22CC and the center-side second supported part 22BC stick to each other by that protrusion, but since the coefficients of linear expansion of the microlens sheet 528 and the prism sheet 529 are equivalent to each other, the center-side third supported part 22CC and the center-side second supported part 22BC are hardly relatively displaced at the time of thermal expansion. Therefore, deformation of an optical sheet 515 due to a catch of a protrusion hardly occurs.

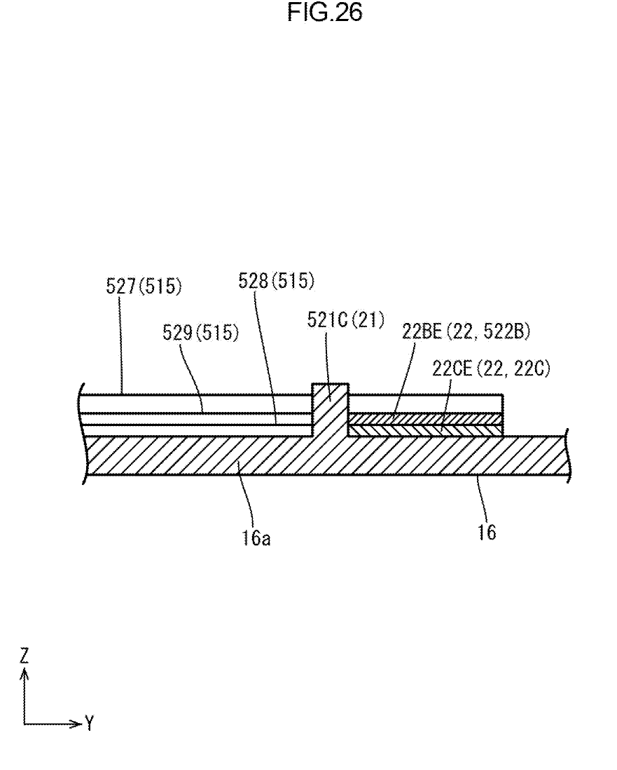

The end-side third sheet support structure has paired end-side third supported parts 22CE protruding from both side ends of the microlens sheet 528 on an upper end in the vertical direction along the horizontal direction, as depicted in FIG. 24 and FIG. 26. The end-side third supported parts 22CE are each formed of a non-opening protrusion piece without having an opening structure as the center-side second supported parts 22BC and the center-side third supported parts 22CC, and its lower end in the vertical direction is supported by a third sheet support part 521C in the vertical direction. These end-side third supported parts 22CE are substantially identical to the third supported parts 22C described in the above-described third embodiment. The end-side second sheet support structure has paired end-side second supported parts 22BE protruding from both side ends of the prism sheet 529 on an upper end in the vertical direction along the horizontal direction. The end-side second supported parts 22BE are disposed so as to be superposed on the above-described end-side third supported parts 22CE in a planar view. The end-side second supported parts 22BE are each formed of a non-opening protrusion piece, as with the end-side third supported parts 22CE, and its lower end in the vertical direction is supported by the common third sheet support part 521C. In this manner, the end-side second sheet support structure and the end-side third sheet support structure are configured so that the end-side second supported parts 22BE and the end-side third supported parts 22CE are collectively supported by the common third sheet support parts 521C.

As described above, according to the present embodiment, the prism sheet 529 has a coefficient of linear expansion smaller than that of a reflective polarizing sheet 527, and the end-side second supported parts 22BE as the second supported parts 522B each form a non-opening protrusion piece shape protruding from the outer edge of the prism sheet 529 along the second direction. With this, since the end-side second supported parts 22BE as the second supported parts 522B each form a protrusion piece shape protruding from the outer edge of the prism sheet 529 along the second direction, and are each supported by the second sheet support part 521B even with non-opening. As being made with non-opening, the size of the end-side second supported part 22BE as the second supported part 522B in the second direction is decreased. Since the prism sheet 529 has a coefficient of linear expansion smaller than that of the reflective polarizing sheet 527, the displacement amount in the second direction with thermal expansion regarding the end-side second supported part 22BE as the second supported part 522B is relatively small, compared with the displacement amount regarding first supported parts 522A. This is suitable for making a backlight device 512 as a narrow picture frame.

### Seventh Embodiment

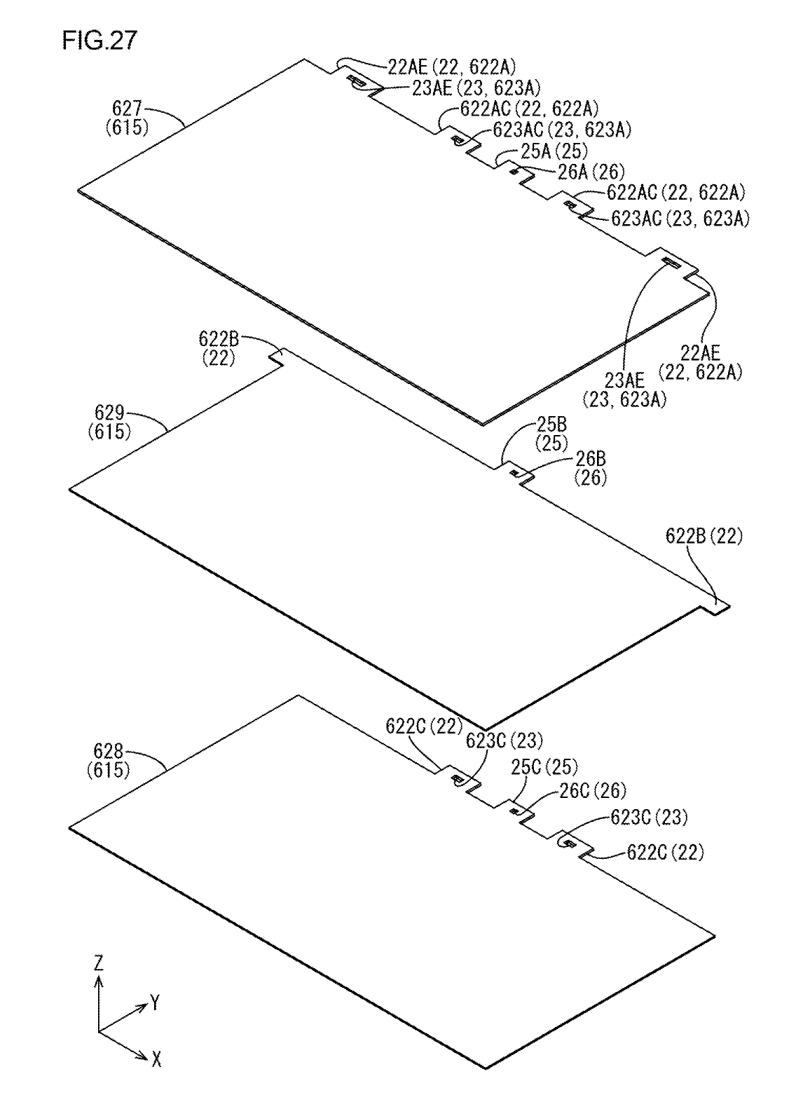

A seventh embodiment of the present invention is described with FIG. 27 to FIG. 30. In this seventh embodiment, one is described in which the second sheet support structure and the third sheet support structure are changed from the above-described third embodiment. Redundant description about the structure, operation, and effect similar to those of the above-described third embodiment is omitted.

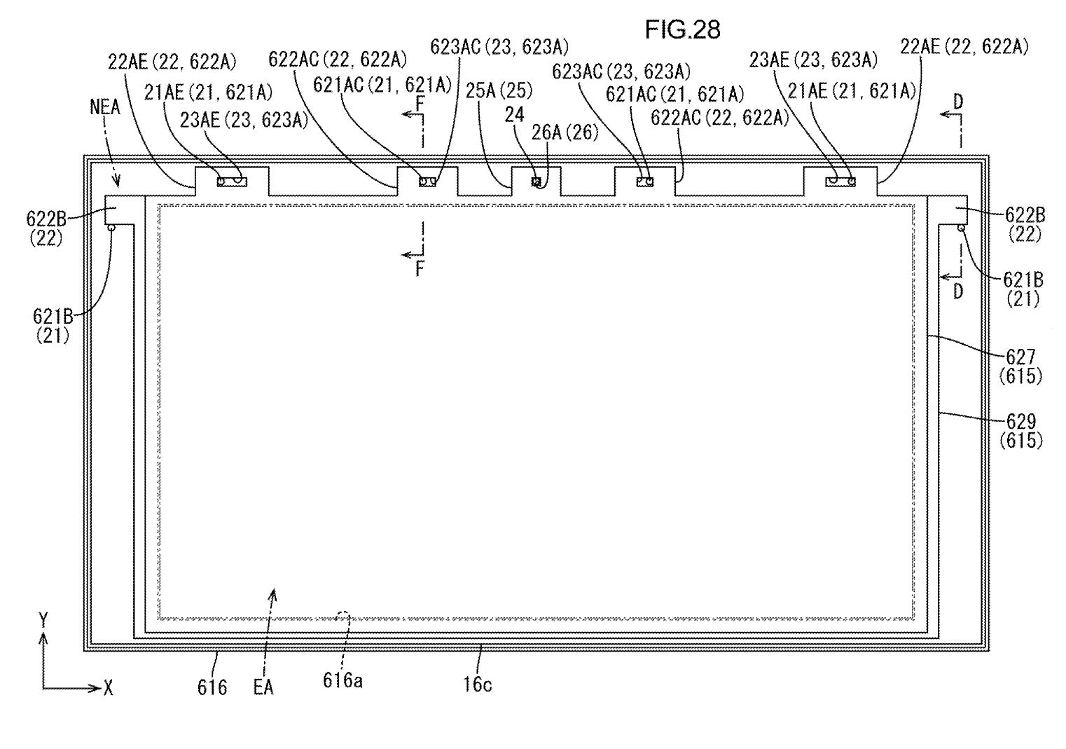

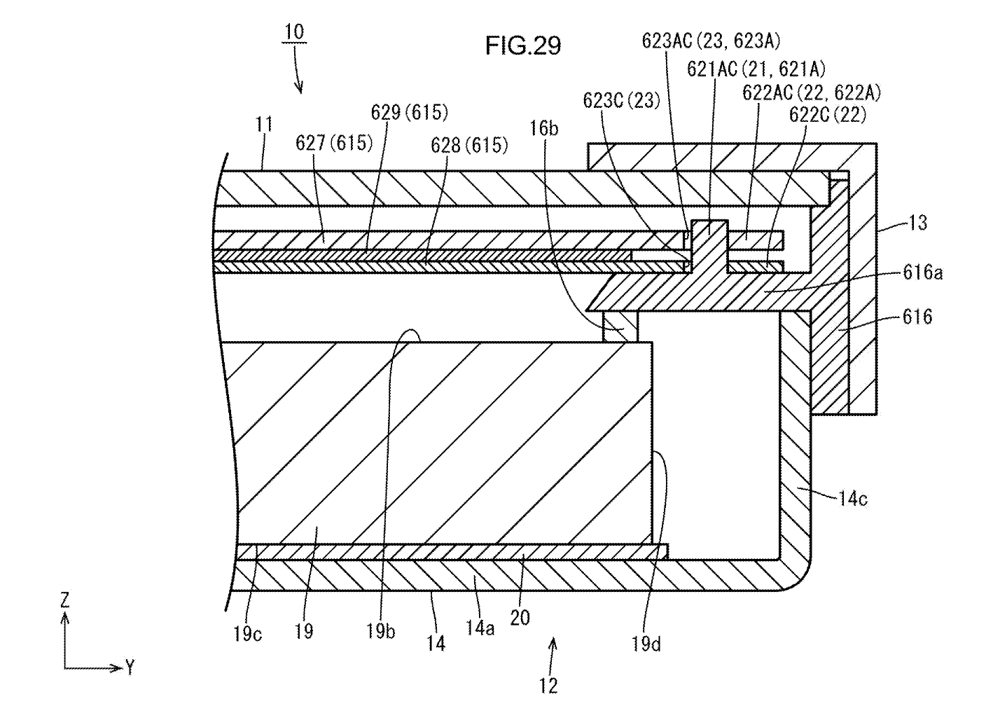

The second sheet support structure according to the present embodiment has paired second supported parts 622B protruding from both side ends of a prism sheet 629 on an upper end in the vertical direction along the horizontal direction, as depicted in FIG. 27 and FIG. 28. The second supported parts 622B are each formed of a non-opening protrusion piece without having an opening structure as the first supported parts 622A and so forth, and has a structure substantially similar to that of the third supported parts 22C described in the above-described third embodiment. The second sheet support structure has paired second sheet support parts 621B which each support a lower end of the second supported part 622B in the vertical direction, as depicted in FIG. 28 and FIG. 29. The second sheet support parts 621B are provided on both short sides of a frame-shaped part 616a of the frame 616 in the horizontal direction, and each forms a columnar shape protruding from the frame-shaped part 616a toward the front side, and has a structure substantially similar to that of the third sheet support part 21C described in the above-described third embodiment.

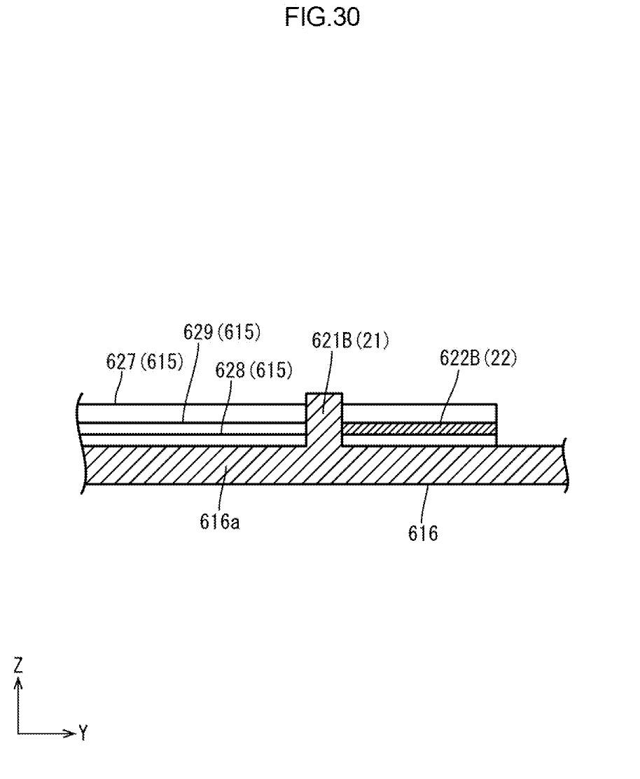

The third sheet support structure has paired third supported parts 622C provided at positions each closer to an end than the center position of the upper end of a microlens sheet 628 in the horizontal direction, as depicted in FIG. 27 and FIG. 28. The paired third supported parts 622C are disposed so as to be superposed on center-side first supported parts 622AC a reflective polarizing sheet 627 has in a planar view. The third supported parts 622C each have a third opening 623C superposed on a center-side first opening 623AC in a planar view and which a center-side first sheet support part 621AC passes through, and supported by the center-side first sheet support part 621AC in the vertical direction, as depicted in FIG. 28 and FIG. 30. In this manner, the first sheet support structure and the third sheet support structure are configured so that the center-side first supported part 622AC and the third supported part 622C are collectively supported by the common center-side first sheet support part 621AC. Since the center-side first supported part 622AC and the third supported part 622C are arranged so as to be superposed each other in a planar view, if a protrusion such as a burr is formed on the opening edge of any center-side first opening 623AC or the opening edge of any third opening 623C, the situation can occur in which the center-side first supported part 622AC and the third supported part 622C stick to each other by that protrusion, but since the protrusion dimension of the protrusion is mostly smaller than the thickness dimension of the prism sheet 629 interposed between a reflective polarizing sheet 627 and the microlens sheet 628, the situation hardly occurs in which the protrusion is caught on any center-side first supported part 622AC or third supported part 622C. Therefore, deformation of an optical sheet 615 due to a catch of a protrusion hardly occurs.

As described above, according to the present embodiment, the device includes the microlens sheet 628 having a surface parallel to the surface of the reflecting polarizing sheet 627, stacked on a side of the prism sheet 629 opposite to the side of the reflecting polarizing sheet 627, and having a coefficient of linear expansion different from at least the coefficient of linear expansion of the reflecting polarizing sheet 627; and the third supported part 622C provided on the one end side of the microlens sheet 628 and at a position superposed on the first supported part 622A, the third supported part 622C having the third opening 623C superposed on the first opening 623A, the third opening 623C which a center-side first sheet support part 621AC as a first sheet support part 621A passes through, and supported by the center-side first sheet support part 621AC as the first sheet support part 621A. With this, the microlens sheet 628 stacked on the side of the prism sheet 629 opposite to the reflective polarizing sheet 627 side is supported in the first direction, with the third supported part 622C provided at the position on one end side in the first direction and superposed on the first supported part 622A being supported by the center-side first sheet support part 621AC as the first sheet support part 621A passing through the third opening 623C superposed on the first opening 623A. Since the first supported part 622A and the third supported part 622C are supported by the center-side first sheet support part 621AC as the common first sheet support part 621A, this is suitable for simplification of the structure. Since the prism sheet 629 is interposed between the reflecting polarizing sheet 627 and the microlens sheet 628, even if a protrusion such as a burr is formed on the opening edge of any first opening 623A or the opening edge of any third opening 623C due to a reason in manufacture, the situation hardly occurs in which that protrusion is caught on the third supported part 622C or the first supported part 622A.

### Eighth Embodiment

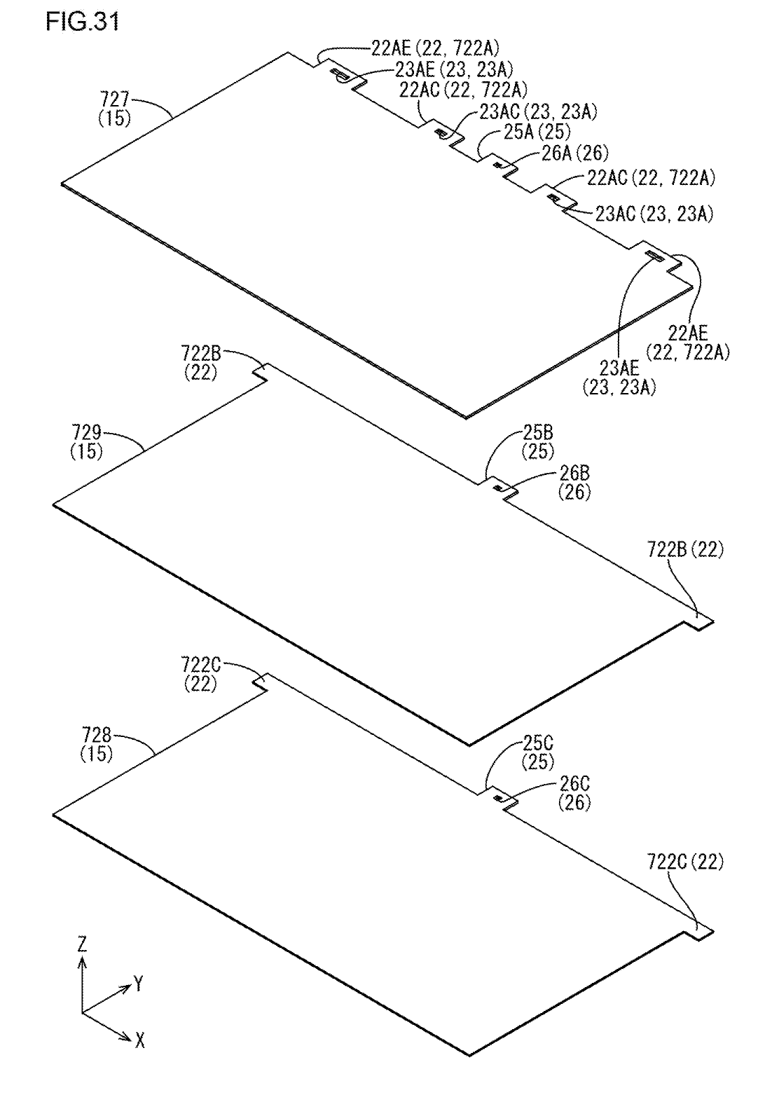

An eighth embodiment of the present invention is described with FIG. 31 to FIG. 33. In this eighth embodiment, one is described in which the second sheet support structure and the third sheet support structure are changed from the above-described sixth embodiment. Redundant description about the structure, operation, and effect similar to those of the above-described sixth embodiment is omitted.

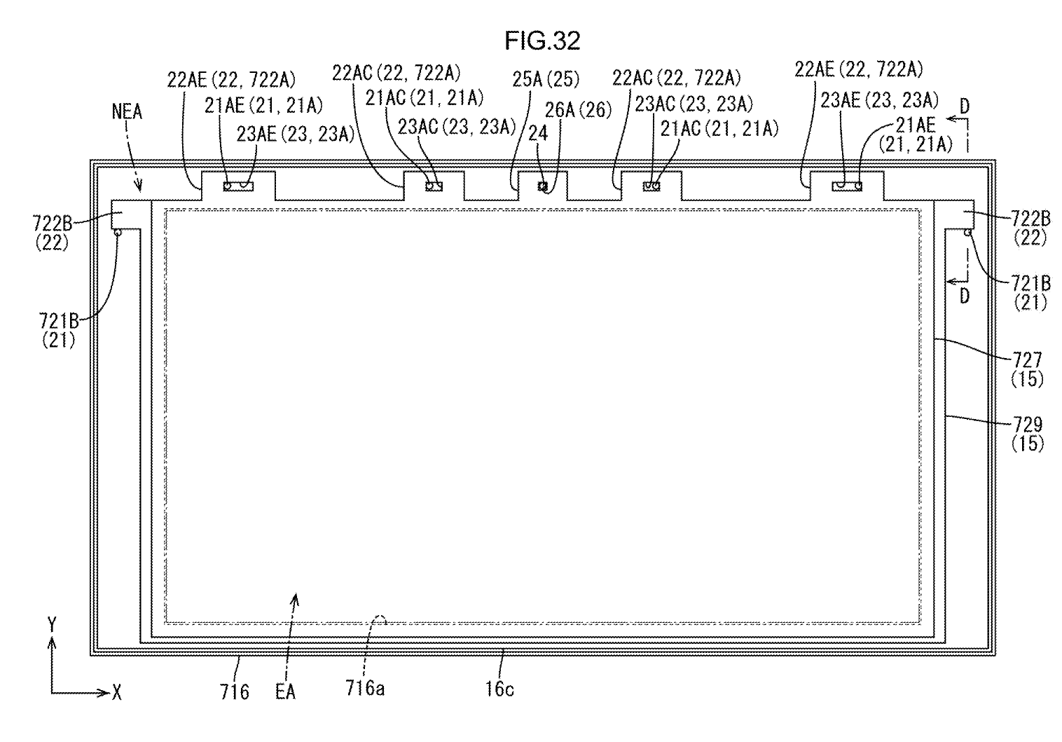

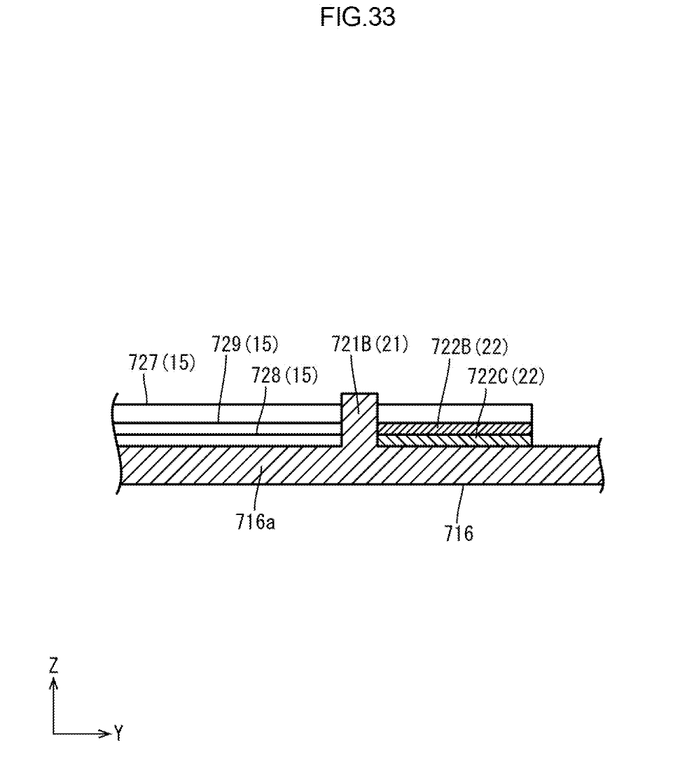

The second sheet support structure and the third sheet support structure according to the present embodiment have the center-side second sheet support structure and the center-side third sheet support structure described in the above-described six embodiment removed, and are formed only of the end-side second sheet support structure and the end-side third sheet support structure. In detail, the second sheet support structure according to the present embodiment has paired second supported parts 722B protruding from upper ends of both side ends of a prism sheet 729 in the vertical direction along the horizontal direction, as depicted in FIG. 31 and FIG. 32. The second supported parts 722B are each formed of a non-opening protrusion piece without having an opening structure as a first supported part 722A, and its lower end in the vertical direction is supported by a second sheet support part 721B in the vertical direction. The second sheet support parts 721B is provided on both short sides of a frame-shaped part 716a of a frame 716 in the horizontal direction, and each form a columnar shape protruding from the frame-shaped part 716a toward the front side, as depicted in FIG. 32 and FIG. 33. The end-side third sheet support structure has paired third supported parts 722C protruding from upper ends of both side ends of a microlens sheet 728 in the vertical direction along the horizontal direction. The third supported parts 722C are disposed at positions so as to be superposed on the above-described second supported parts 722B in a planar view. The third supported parts 722C are each formed of a non-opening protrusion piece, as with the above-described second supported part 722B, and its lower end in the vertical direction is supported by the second sheet support part 721B in the vertical direction. In this manner, the second sheet support structure and the third sheet support structure are configured so that the second supported part 722B and the third supported part 722C both having a non-opening structure are collectively supported by the common second sheet support part 721B. In the present embodiment, among the first supported parts 722A, the second supported part 722B, and the third supported parts 722C, only the first supported part 722A of a reflective polarizing sheet 727 has an opening structure.

As described above, according to the present embodiment, the device includes the microlens sheet 728 having a surface parallel to the surface of the reflecting polarizing sheet 727, stacked on a side of the prism sheet 729 opposite to the side of the reflecting polarizing sheet 727, and having a coefficient of linear expansion equivalent to the coefficient of linear expansion of the prism sheet 729; and the third supported part 722C provided on the one end side of the microlens sheet 728 and at a position superposed on the second supported part 722B and supported by the second sheet support part 721B. With this, the microlens sheet 728 stacked on the side of the prism sheet 729 opposite to the reflective polarizing sheet 727 side is supported in the first direction, with the third supported part 722C provided at the position on one end side in the first direction and superposed on the second supported part 722B being supported by the second sheet support part 721B. Since the second supported part 722B and the third supported part 722C are supported by the common second sheet support part 721B, this is suitable for simplification of the structure. Since the coefficients of linear expansion of the prism sheet 729 and the microlens sheet 728 are equivalent to each other, relative displacement with thermal expansion hardly occurs between the second supported part 722B and the third supported part 722C. Therefore, even if a catch occurs between the second supported part 722B and the third supported part 722C superposed each other, deformation such as a wrinkle hardly occurs in the prism sheet 729 and the microlens sheet 728.

### Other Embodiments

The present invention is not limited to the embodiments described with the above-description and drawings and, for example, the following embodiments are also included in the technical scope of the present invention.

(1) The arrangement of each sheet support part and each supported part described in each embodiment described above in the horizontal direction can be changed as appropriate. For example, By applying the contents described in the above-described fourth embodiment, the arrangement of each sheet support part and each supported part in the horizontal direction described in each embodiment can be replaced. Also, by applying the contents described in the above-described fifth embodiment, an arrangement can be made in which each supported part described in each embodiment is partially superposed.

(2) In each embodiment described above, the structure is described in which one or two sets of the first sheet support structure, the second sheet support structure, and the third sheet support structure are provided. However, three or more sets of at least one of the first sheet support structure, the second sheet support structure, and the third sheet support structure can be installed.

(3) In the above-described second embodiment, the case is described in which, in the structure where two optical sheets are provided, two sets of the first sheet support structure and one set of the second sheet support structure are provided. However, in a structure where three optical sheets are provided, conversely, it is possible to provide one set of the first sheet support structure and two sets of the second sheet support structure.

(4) In the above-described first, second, fourth, and fifth embodiments, the case is described in which, in the structure where two optical sheets are provided, the microlens sheet is disposed on the back side of the reflective polarizing sheet. However, in place of the microlens sheet, a prism sheet can be used. Also, an optical sheet of a type other than the microlens sheet or prism sheet can also be used (such as a diffusion sheet which provides a diffusion action to light or a wavelength conversion sheet containing a phosphor for light wavelength conversion).

(5) In the above-described third and sixth to eighth embodiments, the case is described in which, in the structure where three optical sheets are provided, two sets of the first sheet support structure are provided. However, in the structure where three optical sheets are provided, it is possible to provide one set of the first sheet support structure.

(6) In the above-described third and sixth to eighth embodiments, the case is described in which, in the structure where three optical sheets are provided, the coefficients of linear expansion of the prism sheet and the microlens sheet are equivalent to each other. However, in the structure where three optical sheets are provided, the coefficients of linear expansion of the prism sheet and the microlens sheet may be set differently. In that case, no-superposing arrangement of the second supported part and the third supported part is suitable for preventing sticking between the second supported part and the third supported part.

(7) In the above-described third and sixth to eighth embodiments, a case is possible in which, in the structure where three optical sheets are provided, the prism sheet is disposed and superposed on the front side of the microlens sheet and the microlens sheet is disposed on the front side of the prism sheet in this lamination order.

(8) In the above-described third and sixth to eighth embodiments, the case is described in which, in the structure where three optical sheets are provided, the microlens sheet and the prism sheet are laminated on the back side of the reflective polarizing sheet. However, an optical sheet of a type other than the microlens sheet or prism sheet can also be used (such as a diffusion sheet which provides a diffusion action to light or a wavelength conversion sheet containing a phosphor for light wavelength conversion).

(9) In the above-described third embodiment, the case is described in which the second supported part has an opening structure and the third supported part has a non-opening structure. However, a structure can be adopted in which the second supported part has a non-opening structure, the third supported part has an opening structure, and the third supported part is supported by the third sheet support part provided separately from the first sheet supported part.

(10) From the structure described in the above-described third embodiment, the prism sheet and the second sheet support structure can be removed. In this case, the microlens sheet serves as a “second optical sheet (second sheet member)” superposed on a back side of the reflective polarizing sheet, and a supported part in a non-opening structure the microlens sheet has serves as a “second supported part”.

(11) Other than the structure depicted in the above-described fourth embodiment, the length dimension of each supported part and the length dimension of each opening can be changed as appropriate.

(12) In the above-described sixth embodiment, the case is described in which the second sheet support structure and the third sheet support structure are configured of the center-side second sheet support structure and the center-side third sheet support structure and the end-side second sheet support structure and the end-side third sheet support structure. However, the end-side second sheet support structure and the end-side third sheet support structure can be omitted.

(13) In the above-described seventh embodiment, the case is described in which the third supported part is superposed on the center-side first supported part in a planar view. However, it is possible to adopt a structure in which the third supported part is superposed on the end-side first supported part in a planar view and is supported by the end-side first sheet support part.

(14) In the above-described eighth embodiment, the case is described in which, of the respective supported parts, the second supported part and the third supported part have a non-opening structure and only the first supported part has an opening structure. However, the first supported part and the third supported part may have a non-opening structure and only the second supported part may have an opening structure. Also, the first supported part and the second supported part may have a non-opening structure and only the third supported part may have an opening structure.

(15) In each embodiment described above, the case is described in which the heaviest reflecting polarizing sheet is arranged on the most front side and the microlens sheet and the prism sheet, which have a relatively light weight, are arranged on the back side of the reflective polarizing sheet. However, the reflecting polarizing sheet can be arranged on the back side of the microlens sheet and the prism sheet.

(16) In each embodiment described above, the case is described in which a reflective polarizing sheet is used as a “heavy optical sheet (heavy sheet member)”. However, an optical sheet (diffusion plate which provides a diffusion action to light) of a type other than the reflective polarizing sheet can be used as “heavy optical sheet”.

(17) In each embodiment described above, the case is described in which the sheet support parts are integrally provided to the frame. However, the sheet support parts can be provided to a member other than the frame (such as a light guiding plate, bezel, or chassis).

(18) In each embodiment described above, the case is described in which two or three optical sheets are used. However, as a matter of course, the number of optical sheets to be used can be four or more.

(19) In each embodiment described above, the case is described in which the outer shape of the optical sheet is a rectangle. However, the outer shape of the optical sheet may be a square, circle, oval, or the like. When the outer shape of the optical sheet is changed, the plane shape of the frame is also changed accordingly.

(20) In each embodiment described above, exemplarily described is the backlight device (liquid crystal display device) in a landscape orientation in which the short side direction of the optical sheet matches the vertical direction and the long side direction thereof matches the horizontal direction. However, as a matter of course, a backlight device (liquid crystal display device) in a portrait orientation in which the long side direction of the optical sheet matches the vertical direction and the short side direction thereof matches the horizontal direction.

(21) In each embodiment described above, one is depicted in which the LED substrate (LED) is arranged so that the end face on the lower long side of the light guiding plate in the vertical direction serves as a input light end face. However, the LED substrate (LED) can be arranged so that the end face on the upper long side of the light guiding plate in the vertical direction serves as a input light end face. Also, the LED substrate (LED) can be arranged so that any of end faces on the paired short sides of the light guiding plate in the horizontal direction serves as an input end face.

(22) In each embodiment described above, a one-side input light type is described in which the LED substrate (LED) is arranged so that only one end face of the four end faces of the light guiding plate serves as an input light end face. However, a both-side input light type can be adopted in which paired LED substrates (LEDs) interpose the light guiding plate in the short-side direction so that the end faces on the paired long sides of the four end faces of the light guiding plate serve as input light end faces. Also, a both-side input light type can be adopted in which paired LED substrates (LEDs) interpose the light guiding plate in the long-side direction so that the end faces on the paired short sides of the four end faces of the light guiding plate serve as input light end faces.

(23) Other than the above-described (22), the LED substrate (LED) can be arranged so that end faces on any three sides of the light guiding plate serve as input light end faces, or the LED substrate (LED) can also be arranged so that all end faces on the four sides of the light guiding plates serve as input light end faces.

(24) In each embodiment described above, one is described in which one LED substrate is arranged on one side of the light guiding plate. However, a plurality of LED substrates may be arranged on one side of the light guiding plate.

(25) In each embodiment described above, the LED of a top-face light emission type is described. However, an LED of a side-face light emission type can be used as a light source. Also, the number of implementation of LEDs on the LED substrate can be changed as appropriate. Also, a light source other than the LED (such as an organic EL) can be used.

(26) In each embodiment described above, a backlight device of an edge-light type is exemplarily described. However, the present invention can be applied also to a backlight device of a downlight type. In this case, the backlight device of the downlight type does not have a light guiding plate included in the backlight device of the edge-light type, and the LED substrate is arranged so that the mount surface of LEDs is in parallel to the plate surface of the bottom surface of the chassis and is opposed, with a space, to the plate surface of the optical sheet arranged on a light emission part in the chassis. The LED substrate is preferably arranged so that LEDs are disposed in a matrix in the surface of the bottom part of the chassis. Also, preferably, the reflective sheet is installed so as to cover the mount surface of the LED substrate and an LED insertion hole which each LED passes through are formed in that reflective sheet. Furthermore, a diffusion lens can also be installed which diffuses light so as to cover the light emission surface of the LEDs.

(27) In each embodiment described above, a TFT is used as a switching element of the liquid crystal display device. However, the present invention can be applied also to a liquid crystal display device using a switching element other than the TFT (for example, thin film diode (TFD)), and can be applied not only to a liquid crystal display device for color display but also to a liquid crystal display device for monochrome display.

(28) In each embodiment described above, a liquid crystal display device of a transmission type is exemplarily described. Other than that, the present invention can be applied also to a liquid crystal display device of a half-transmission type.

(29) In each embodiment described above, a liquid crystal display device using a liquid crystal panel as a display panel is exemplarily described. However, the present invention can be applied also to a display device using a display panel of another type (for example, such as MEMS (Micro Electro Mechanical Systems) display panel).

(30) In each embodiment described above, a television receiving device including a tuner is exemplarily described. However, the present invention can be applied also to one not including a tuner. Specifically, the present invention can be applied also to a liquid crystal display device to be used as an electronic signage (digital signage) or electronic blackboard. Also, a specific screen size of the liquid crystal panel can be changed as appropriate.

### EXPLANATION OF SYMBOLS

10: liquid crystal display device (display device)
11: liquid crystal panel (display panel)
12, 212, 512: backlight device (lighting device)
16, 116, 216, 616, 716: frame (frame-shaped member)
21A, 121A, 321A, 621A: first sheet support part
21B, 321B, 521B, 621B, 721B: second sheet support part
21C, 521C: third sheet support part
22A, 122A, 222A, 322A, 422A, 522A, 622A, 722A: first supported part
22B, 122B, 222B, 322B, 422B, 522B, 622B, 722B: second supported part
22C, 622C, 722C: third supported part
23A, 223A, 323A, 423A, 623A: first opening
23B, 123B, 223B, 323B, 423B: second opening
23C, 523C, 623C: third opening
24, 124, 224: center-side sheet support part
25A, 125A, 225A: first center-side supported part
25B, 225B: second center-side supported part
26A, 226A: first center-side opening
26B, 226B: second center-side opening
27, 127, 527, 627, 727: reflective polarizing sheet (first sheet member, first optical sheet, heavy sheet member, thick sheet member)
28, 128: microlens sheet (second sheet member, second optical sheet, light-weight sheet member, thin sheet member, small-coefficient-of-linear-expansion sheet member)
29, 529, 629, 729: prism sheet (second sheet member, second optical sheet, light-weight sheet member, thin sheet member, small-coefficient-of-linear-expansion sheet member)
228, 528, 628, 728: microlens sheet (third sheet member, light-weight sheet member, thin sheet member, small-coefficient-of-linear-expansion sheet member)
EA: effective output light area

1. A lighting device comprising:
a first sheet member having a surface parallel to a first direction and a second direction orthogonal to each other;
a first sheet support part which supports one end side of the first sheet member in the first direction;
a first supported part provided on the one end side of the first sheet member and close to an end with respect to a center position in the second direction, having a first opening which the first sheet support part passes through, and supported by the first sheet support part;
a second sheet member having a surface parallel to the surface of the first sheet member, stacked on the first sheet member, and having a coefficient of linear expansion different from a coefficient of linear expansion of the first sheet member;
a second sheet support part which supports the one end side of the second sheet member; and
a second supported part provided on the one end side of the second sheet member and close to the end with respect to the center position in the second direction and supported by the second sheet support part, the second supported part disposed at a position not superposed on at least the first opening.

2. The lighting device according to claim 1, wherein the second supported part has a second opening which the second sheet support part passes through.

3. The lighting device according to claim 2, wherein the second supported part has the second opening disposed at a position not superposed on the first supported part.

4. The lighting device according to claim 1, wherein the second supported part is disposed at a position not superposed on the first supported part.

5. The lighting device according to claim 1, comprising:
a center-side sheet support part which supports a center side in the second direction on the one end side of the first sheet member and the second sheet member;
a first center-side supported part provided on the one end side of the first sheet member and at a center position in the second direction, having a first center-side opening which the center-side sheet support part passes through, and supported by the center-side sheet support part; and
a second center-side supported part provided on the one end side of the second sheet member and at the center position in the second direction, superposed on the first center-side opening, having a second center-side opening which the center-side sheet support part passes through, and supported by the center-side sheet support part.

6. The lighting device according to claim 1, wherein
either one of the first sheet member and the second sheet member serves as a heavy sheet member which is relatively heavy and another one serves as a light-weight sheet member which has a relatively light weight, and
the heavy sheet member has a larger number of installations of the first supported part or the second supported part than the light-weight sheet member.

7. The lighting device according to claim 1, wherein
the second sheet member has the coefficient of linear expansion smaller than the coefficient of linear expansion of the first sheet member, and
the second supported part forms a non-opening protrusion piece shape protruding from an outer edge of the second sheet member along the second direction.

8. The lighting device according to claim 1, wherein
either one of the first sheet member and the second sheet member serves as a thick sheet member which is relatively thick and another one serves as a thin sheet member which is relatively thin, and
the thin sheet member is disposed so as to be stacked on a side of the thick sheet member opposite to an output light side.

9. The lighting device according to claim 1, wherein
the first sheet member and the second sheet member serve as a first optical sheet and a second optical sheet, respectively, each of which provides optical action to light,
the lighting device comprises a frame-shaped member which forms a frame shape so as to extend along an outer edge of the first optical sheet and the second optical sheet and also delimits an effective output light area of the first optical sheet and the second optical sheet, and
the first sheet support part and the second sheet support part are provided to the frame-shaped member.

10. The lighting device according to claim 1, comprising:
a third sheet member having a surface parallel to the surface of the first sheet member, stacked on a side of the second sheet member opposite to the first sheet member side, and having a coefficient of linear expansion different from at least the coefficient of linear expansion of the first sheet member;
a third sheet support part which supports the one end side of the third sheet member; and
a third supported part provided on the one end side of the third sheet member and close to an end with respect to a center position in the second direction and supported by the third sheet support part, the third supported part disposed at a position not superposed on the first supported part and the second supported part.

11. The lighting device according to claim 10, wherein
at least either one of the second sheet member and the third sheet member serves as a small-coefficient-of-linear-expansion sheet member having the coefficient of linear expansion smaller than the coefficient of linear expansion of the first sheet member, and
at least either one of the second supported part and the third supported part included in the small-coefficient-of-linear-expansion sheet member forms a non-open protrusion piece shape protruding from an outer edge of the small-coefficient-of-linear-expansion sheet member along the second direction.

12. The lighting device according to claim 1, comprising:
a third sheet member having a surface parallel to the surface of the first sheet member, stacked on a side of the second sheet member opposite to the first sheet member side, and having a coefficient of linear expansion different from at least the coefficient of linear expansion of the first sheet member; and
a third supported part provided on the one end side of the third sheet member and at a position superposed on the first supported part, the third supported part having a third opening superposed on the first opening, the third opening which the first sheet support part passes through, and supported by the first sheet support part.

13. The lighting device according to claim 1, comprising:
a third sheet member having a surface in parallel with the surface of the first sheet member, stacked on a side of the second sheet member opposite to the first sheet member side, and having a coefficient of linear expansion equivalent to the coefficient of linear expansion of the second sheet member; and
a third supported part provided on the one end side of the third sheet member and at a position superposed on the second supported part, the third supported part supported by the second sheet support part.

14. A display device comprising:
the lighting device according to claim 1, and
a display panel which displays an image by using light applied from the lighting device.
